(19) United States
(12) Patent Application Publication
(10) Pub. No.: US 2025/0106934 A1
(43) Pub. Date: Mar. 27, 2025

(54) PDCCH MONITORING INDICATION IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US); Emad Nader Farag, Flanders, NJ (US)

(21) Appl. No.: 18/826,092

(22) Filed: Sep. 5, 2024

Related U.S. Application Data
(60) Provisional application No. 63/539,738, filed on Sep. 21, 2023.

(51) Int. Cl. H04W 76/28; H04W 72/23

(52) U.S. Cl. CPC H04W 76/28; H04W 72/23

(57) ABSTRACT

Apparatuses and methods for monitoring indications for physical downlink control channels (PDCCHs) in full-duplex (FD) systems. A method includes receiving a set of discontinuous reception (DRX) parameters associated with a subband full-duplex (SBFD) configuration and receiving a first PDCCH that provides a downlink control information (DCI) format. The DCI format includes a wake-up indication field enabling or disabling receptions of a second PDCCH, in a DRX on-period, for a symbol or a subband type. The method further includes selecting, based on the wake-up indication field, the symbol or the subband type for receptions of the second PDCCH and receiving, based on (i) the selected symbol or subband type and (ii) the set of DRX parameters, the second PDCCH at a first occasion in a DRX on-duration or during a DRX active time. The first occasion is after reception of the first PDCCH and before an end duration.

### CROSS-REFERENCE TO RELATED AND CLAIM OF PRIORITY

The present application claims priority under 35 U.S.C. § 119(e) to U.S. Provisional Patent Application No. 63/539,738 filed Sep. 21, 2023, which is hereby incorporated by reference in its entirety.

### TECHNICAL FIELD

The present disclosure relates generally to wireless communication systems and, more specifically, the present disclosure is related to monitoring indications for physical downlink control channels (PDCCHs) in full-duplex (FD) systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a PDCCH monitoring indication in FD systems.

In one embodiment, a method for a user equipment (UE) to receive PDCCHs is provided. The method includes receiving a set of discontinuous reception (DRX) parameters associated with a subband full-duplex (SBFD) configuration and receiving a first PDCCH that provides a downlink control information (DCI) format. The DCI format includes a wake-up indication field enabling or disabling receptions of a second PDCCH, in a DRX on-period associated with a DRX cycle, for a symbol or a subband type. The enabling or disabling of receptions of the second PDCCH is based on the set of DRX parameters. The method further includes selecting, based on the wake-up indication field, the symbol or the subband type for receptions of the second PDCCH and receiving, based on (i) the selected symbol or subband type and (ii) the set of DRX parameters, the second PDCCH at a first occasion in a DRX on-duration or during a DRX active time. The first occasion is after reception of the first PDCCH and before an end of a time duration. The symbol or subband type is one of: an SBFD symbol or a non-SBFD symbol, a downlink (DL) or a flexible symbol for an SBFD symbol, or a first SBFD DL subband, a second SBFD DL subband, an SBFD flexible subband, or an SBFD UL subband.

In another embodiment, a UE is provided. The UE includes a transceiver configured to receive a set of DRX parameters associated with a SBFD configuration; and receive a first PDCCH that provides a control information DCI format. The DCI format includes a wake-up indication field enabling or disabling receptions of a second PDCCH, in a DRX on-period associated with a DRX cycle, for a symbol or a subband type. The enabling or disabling of receptions of the second PDCCH is based on the set of DRX parameters. The UE further includes a processor operably coupled to the transceiver. The processor is configured to select, based on the wake-up indication field, the symbol or the subband type for receptions of the second PDCCH. The transceiver is further configured to receive, based on (i) the selected symbol or subband type and (ii) the set of DRX parameters, the second PDCCH at a first occasion in a DRX on-duration or during a DRX active time. The first occasion is after reception of the first PDCCH and before an end of a time duration. The symbol or subband type is one of: an SBFD symbol or a non-SBFD symbol, a DL or a flexible symbol for an SBFD symbol, or a first SBFD DL subband, a second SBFD DL subband, an SBFD flexible subband, or an SBFD UL subband.

In yet another embodiment, a base station (BS) is provided. The BS includes a processor and a transceiver operably coupled to the processor. The transceiver is configured to configured to transmit a set of DRX parameters associated with a SBFD configuration and transmit a first PDCCH that provides a DCI format. The DCI format includes a wake-up indication field enabling or disabling receptions of a second PDCCH, in a DRX on-period associated with a DRX cycle, for a symbol or a subband type. The enabling or disabling of receptions of the second PDCCH is based on the set of DRX parameters. The wake-up indication field indicates the symbol or the subband type for of the second PDCCH. The transceiver is further configured to transmit, based on (i) the selected symbol or subband type and (ii) the set of DRX parameters, the second PDCCH at a first occasion in a DRX on-duration or during a DRX active time. The first occasion is after transmission of the first PDCCH and before an end of a time duration. The symbol or subband type is one of: an SBFD symbol or a non-SBFD symbol, a DL or a flexible symbol for an SBFD symbol, or a first SBFD DL subband, a second SBFD DL subband, an SBFD flexible subband, or an SBFD UL subband.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for physical downlink shared channel (PDSCH) in a subframe according to embodiments of the present disclosure;

FIG. 6 illustrates an example of a receiver structure for PDSCH in a subframe according to embodiments of the present disclosure;

FIG. 7 illustrates an example of a transmitter structure for physical uplink shared channel (PUSCH) in a subframe according to embodiments of the present disclosure;

FIG. 8 illustrates an example of a receiver structure for a PUSCH in a subframe according to embodiments of the present disclosure;

FIG. 9 illustrates an example of a transmitter structure for beamforming according to embodiments of the present disclosure;

FIG. 10 illustrates a timeline of an example time division duplexing (TDD) configuration according to embodiments of the present disclosure;

FIG. 11 illustrates timelines of example FD configurations according to embodiments of the present disclosure;

FIG. 12 illustrates an example of a transmitter structure for a PDCCH according to embodiments of the present disclosure;

FIG. 13 illustrates an example of a receiver structure for a PDCCH according to embodiments of the present disclosure;

FIG. 14 illustrates an example process flowchart of a wake-up indication associated with PDCCH reception in a discontinuous reception (DRX) on-period for a slot or symbol type or for an subband-dull-duplex (SBFD)subband type in a FD communication system according to embodiments of the present disclosure;

FIG. 15 illustrates an example process flowchart of a wake-up indication associated with PDCCH reception in a DRX on-period for an SBFD configuration in a FD communication system according to embodiments of the present disclosure; and

FIG. 16 illustrates an example process flowchart of channel state information (CSI) reporting in a power savings (PS) mode during DRX operation in a FD communication system according to embodiments of the present disclosure.

### DETAILED DESCRIPTION

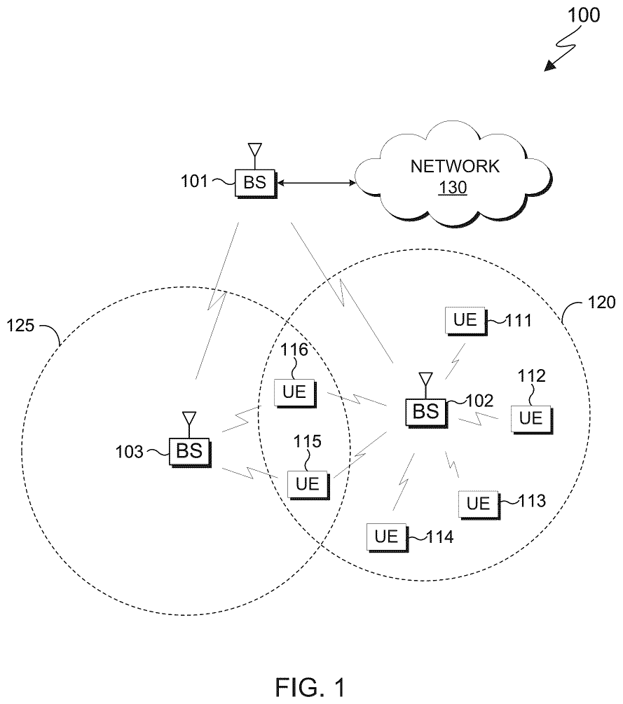

FIGS. 1-16 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein:
[1]3GPP TS 38.211 v17.5.0, “NR; Physical channels and modulation;”
[2]3GPP TS 38.212 v17.5.0, “NR; Multiplexing and Channel coding;”
[3]3GPP TS 38.213 v17.6.0, “NR; Physical Layer Procedures for Control;”
[4]3GPP TS 38.214 v17.6.0, “NR; Physical Layer Procedures for Data;”
[5]3GPP TS 38.321 v17.5.0, “NR; Medium Access Control (MAC) protocol specification;”
[6]3GPP TS 38.331 v17.5.0, “NR; Radio Resource Control (RRC) Protocol Specification;”
[7]3GPP TS 38.133 v17.10.0, “NR; Requirements for support of radio resource management;”
[8]3GPP TS 38.300 v17.5.0, “NR; NR and NG-RAN Overall Description; Stage 2;”
[9]3GPP TS 38.306 v17.5.0, “NR; User Equipment (UE) radio access capabilities;” and
[10]3GPP TS 38.822 v17.1.0, “NR; User Equipment (UE) feature list.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for PDCCH monitoring indications in FD systems. In certain embodiments, one or more of the gNBs 101-103 include circuitry, programing, or a combination thereof to support PDCCH monitoring indications in FD systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

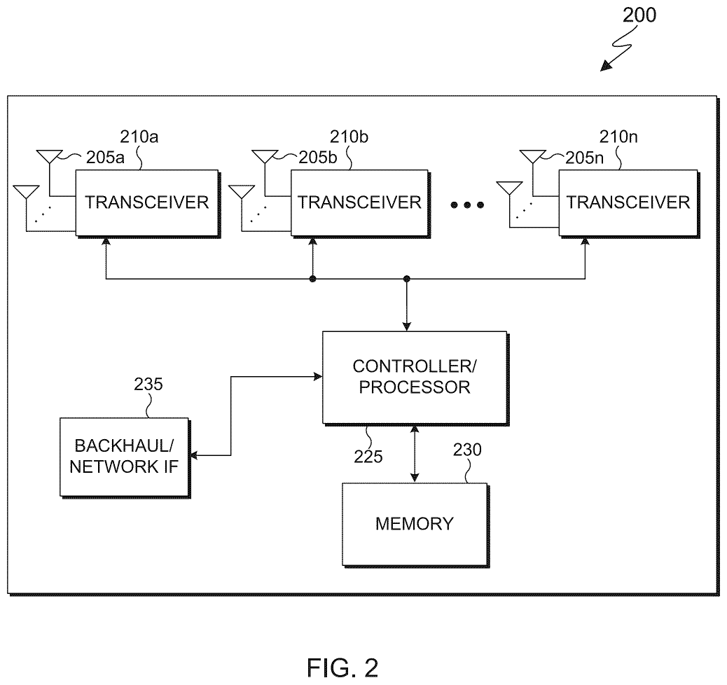

FIG. 2 illustrates an example TRP 200 according to embodiments of the present disclosure. For example, the TRP 200 any be a base station, such as gNB 101-103, or may be an NCR or smart repeater (SR), such as the relay node 104 in FIG. 1. The embodiment of the TRP 200 illustrated in FIG. 2 is for illustration only. However, TRPs come in a wide variety of configurations, and FIG. 2 does not limit the scope of this disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs or gNBs in the network 100. In various embodiments, certain of the transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals. For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for PDCCH monitoring indications in FD systems. Any of a wide variety of other functions could be supported in the TRP 200 by the controller/processor 225.

The controller/processor 225 is also capable of executing programs and other processes resident in the memory 230, such as processes to support PDCCH monitoring indications in FD systems. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 5G/NR, LTE, or LTE-A), the interface 235 could allow the TRP 200 to communicate with other gNBs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 200 is implemented as an access point, the interface 235 could allow the TRP 200 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

In various embodiments, the TRP 200 may be utilized as an NCR or SR. For example, the TRP 200 may communicate with a base station 102 via a wireless backhaul over interface 235 via a NCT-MT entity for control information and may communicate via transceivers 210 with the UE 116 to communicate data information via an NCR-Fwd entity as described in greater detail below.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

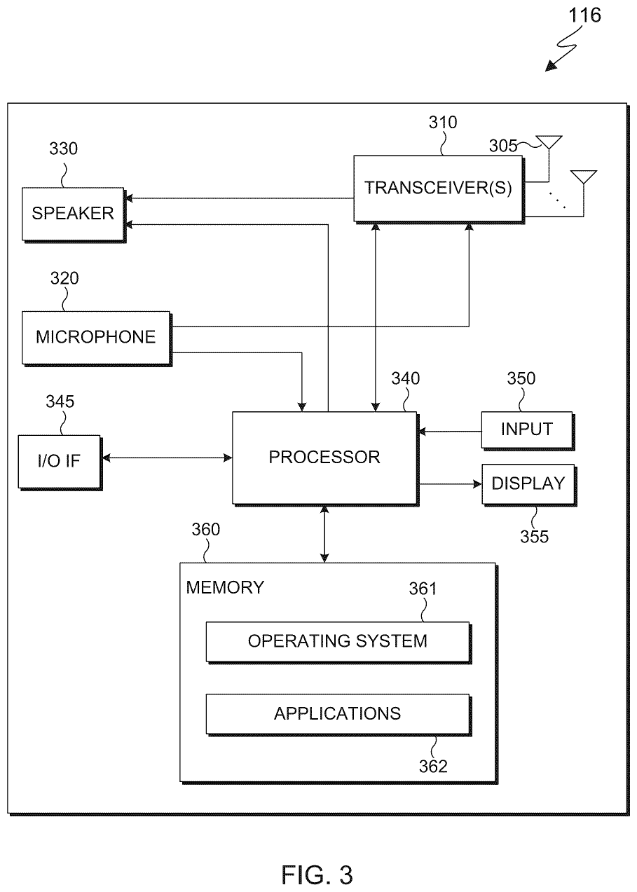

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for PDCCH monitoring indications in FD systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

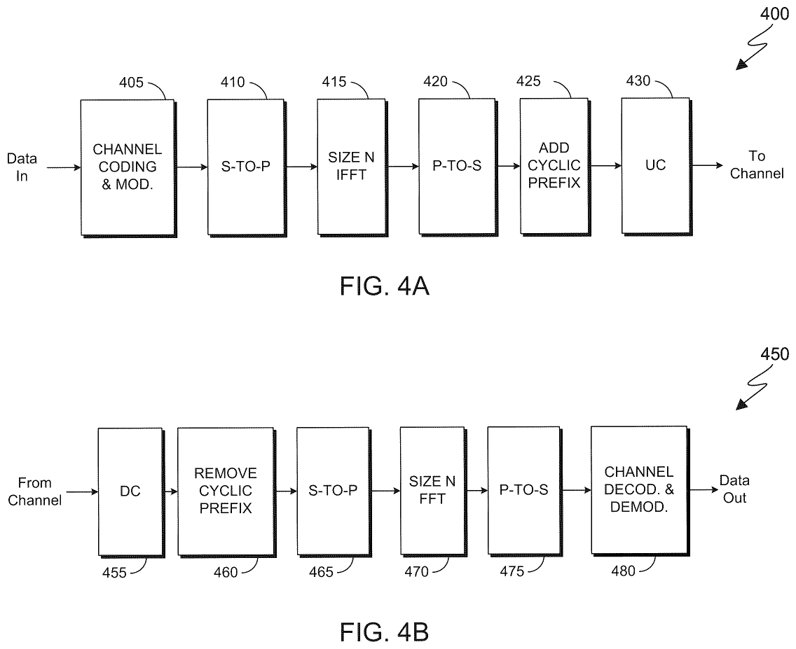

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or TRP 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for enabling PDCCH monitoring indications in FD systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 or the TRP 200 and may implement a receive path 450 for receiving in the downlink from the gNBs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although this disclosure is directed to an embodiment that implements the Fast Fourier Transform and the Inverse Fast Fourier Transform, this is by way of illustration only and may not be construed to limit the scope of the disclosure. It may be appreciated that in an alternate embodiment of the present disclosure, the Fast Fourier Transform functions and the Inverse Fast Fourier Transform functions may easily be replaced by discrete Fourier transform (DFT) functions and inverse discrete Fourier transform (IDFT) functions, respectively. It may be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in [2], are referred for brevity as a unicast DCI format. A DCI format scheduling PDSCH reception for multicast communication, such as a DCI format with CRC scrambled by G-RNTI/G-CS-RNTI as described in [2], are referred to as multicast DCI format. DCI formats providing various control information to at least a subset of UEs in a serving cell, such as DCI format 2_0 in [2], are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the PCI of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2ⁿ. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

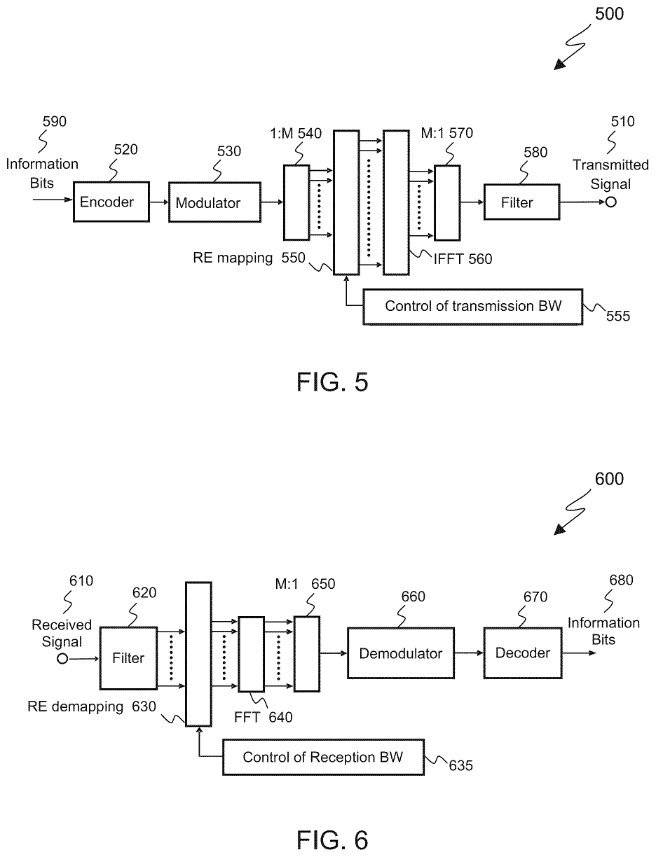

FIG. 5 illustrates an example of a transmitter structure 500 for PDSCH in a subframe according to embodiments of the present disclosure. For example, transmitter structure 500 can be implemented in gNB 102 of FIG. 1. This example is for illustration only and other embodiments can be used without departing from the scope of the present disclosure.

As illustrated in FIG. 5, information bits 510 are encoded by encoder 520, such as a turbo encoder, and modulated by modulator 530, for example using Quadrature Phase Shift Keying (QPSK) modulation. A Serial to Parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse Fast Fourier Transform (IFFT), the output is then serialized by a Parallel to Serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates an example of a receiver structure 600 for PDSCH in a subframe according to embodiments of the present disclosure. For example, receiver structure 600 can be implemented by any of the UEs 111-116 of FIG. 1. This example is for illustration only and other embodiments can be used without departing from the scope of the present disclosure.

As illustrated in FIG. 6, a received signal 610 is filtered by filter 620, REs 630 for an assigned reception BW are selected by BW selector 635, unit 640 applies a Fast Fourier Transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

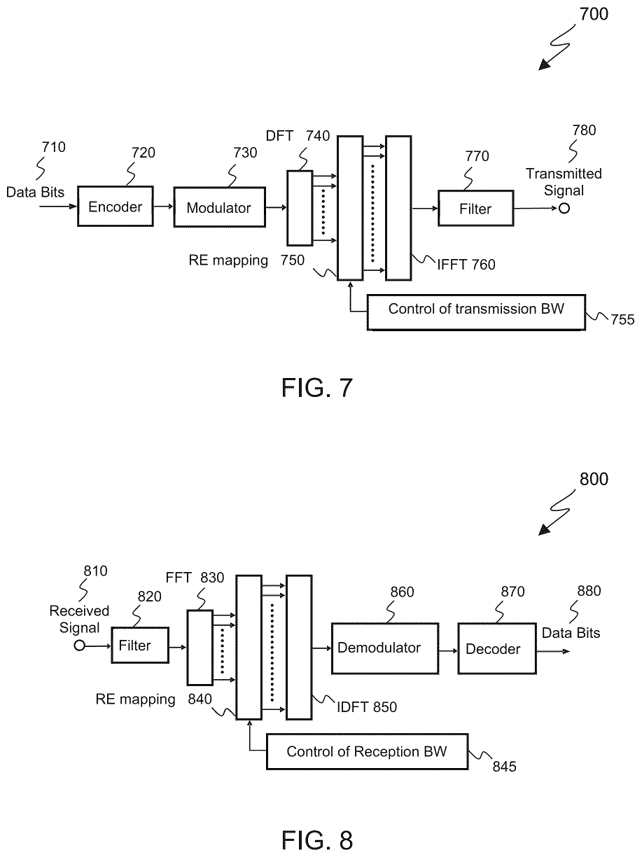

FIG. 7 illustrates an example of a transmitter structure 700 for PUSCH in a subframe according to embodiments of the present disclosure. For example, transmitter structure 700 can be implemented in gNB 102 of FIG. 1. This example is for illustration only and other embodiments can be used without departing from the scope of the present disclosure.

As illustrated in FIG. 7, information data bits 710 are encoded by encoder 720, such as a turbo encoder, and modulated by modulator 730. A Discrete Fourier Transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates an example of a receiver structure 800 for a PUSCH in a subframe according to embodiments of the present disclosure. For example, receiver structure 800 can be implemented by any of the UEs 111-116 of FIG. 1. This example is for illustration only and other embodiments can be used without departing from the scope of the present disclosure.

As illustrated in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an Inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

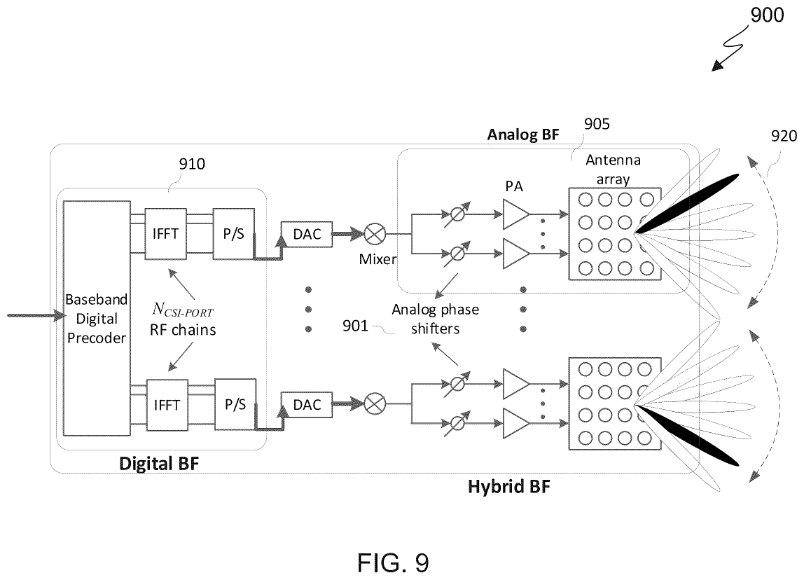

FIG. 9 illustrates an example of a transmitter structure 900 for beamforming according to embodiments of the present disclosure. In certain embodiments, one or more of gNB 102 or UE 116 includes the transmitter structure 900. For example, one or more of antenna 205 and its associated systems or antenna 305 and its associated systems can be included in transmitter structure 900. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 9. Then, one CSI-RS port can be mapped onto a large number of antenna elements that can be controlled by a bank of analog phase shifters 901. One CSI-RS port can then correspond to one sub-array which produces a narrow analog beam through analog beamforming 905. This analog beam can be configured to sweep across a wider range of angles 920 by varying the phase shifter bank across symbols or slots/subframes. The number of sub-arrays (equal to the number of RF chains) is the same as the number of CSI-RS ports NCS-PORT. A digital beamforming unit 910 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 900 of FIG. 9 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 9 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mₙ subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

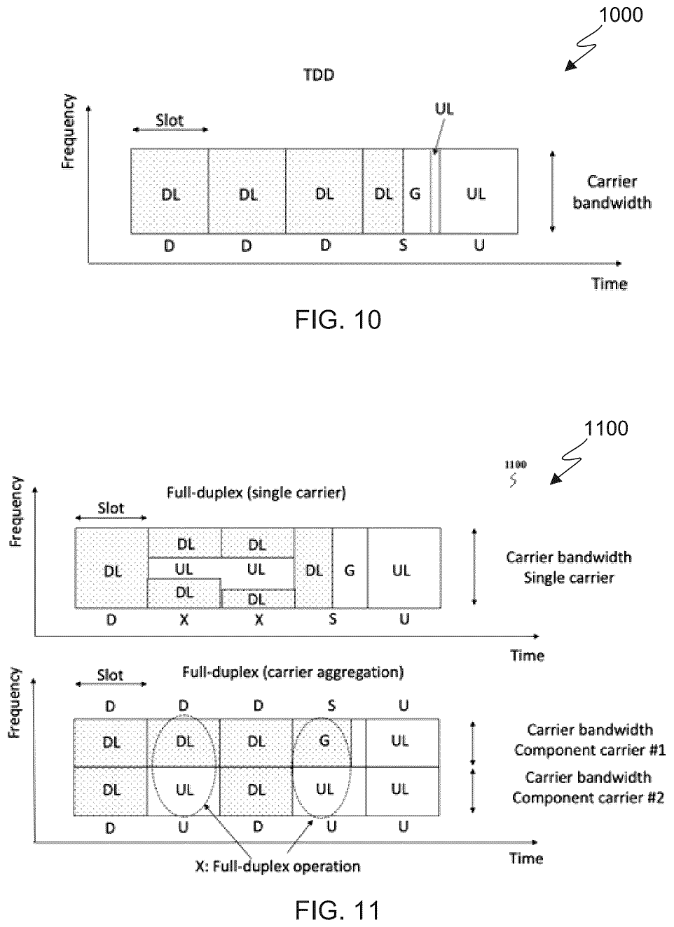

FIG. 10 illustrates a timeline 1000 of an example TDD configuration according to embodiments of the present disclosure. For example, the timeline 1000 of an example TDD configuration can be followed by any of the UEs 111-116 and the gNB 102 of FIG. 1. This example is for illustration only and other embodiments can be used without departing from the scope of the present disclosure.

With reference to FIG. 10, a DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in [3], that can indicate a link direction of some flexible symbols in one or more slots. Nevertheless, in actual deployments, it is difficult for a gNB scheduler to adapt a transmission direction of symbols without coordination with other gNB schedulers in the network. This is because of CLI where, for example, DL receptions in a cell by a UE can experience large interference from UL transmissions in the same or neighboring cells from other UEs.

FD communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap.

A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. FD operation using an UL subband or a DL subband may be referred to as SBFD.

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Embodiments of the present invention recognize that full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, the term FD is used as a short form for a full-duplex operation in a wireless system. The terms ‘cross-division-duplex’ (XDD), ‘full duplex’ (FD) and ‘subband-full-duplex’ (SBFD) may be used interchangeably in the disclosure.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

FIG. 11 illustrates timelines 1100 of example FD configurations according to embodiments of the present disclosure. For example, timelines 1100 of example FD configurations can be followed by any of the UEs 111-116 and the gNB 102 of FIG. 1. This example is for illustration only and other embodiments can be used without departing from the scope of the present disclosure.

With reference to FIG. 11, for a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation.

Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrates diagrams, various changes may be made to the diagrams 1000-1100 of FIGS. 10-11. For example, while certain diagrams (such as diagrams 1000, 1100) describe a certain slot structure, various components combined, further subdivided, or omitted and additional components can be added according to particular needs.

Embodiments of the present disclosure recognize that using Rel-15 NR, a UE can monitor multiple candidate locations for respective potential PDCCH receptions to decode multiple DCI formats in a slot, for example as described in [3]. A DCI format includes cyclic redundancy check (CRC) bits in order for the UE to confirm a correct detection of the DCI format. A DCI format type is identified by a radio network temporary identifier (RNTI) that scrambles the CRC bits, for example as described in [2].

For a DCI format scheduling a PDSCH or a PUSCH to a single UE, the RNTI can be a cell RNTI (C-RNTI), or a configured scheduling RNTI (CS-RNTI), or an MCS-C-RNTI and serves as a UE identifier. In the following, for brevity, only the C-RNTI will be referred to when needed. A UE typically receives/monitors PDCCH for detections of DCI formats with CRC scrambles by a C-RNTI according to a UE-specific search space (USS).

For a DCI format scheduling a PDSCH conveying system information (SI), the RNTI can be an SI-RNTI. For a DCI format scheduling a PDSCH providing a random-access response (RAR), the RNTI can be an RA-RNTI. For a DCI format scheduling a PDSCH providing paging information, the RNTI can be a P-RNTI. There are also a number of other RNTIs that are provided to a UE by UE-specific RRC signaling and are associated with DCI formats providing various control information and are monitored according to a common search space (CSS). Such DCI formats include a DCI format 2_0 providing a structure of a slot in term of DL, UL or flexible/reserved symbols over a number of slots, a DCI format 2_2 providing transmit power control (TPC) commands for PUSCH or PUCCH transmissions, a DCI format 2_3 providing TPC commands for SRS transmissions and also potentially triggering a SRS transmission on a number of cells, and so on, and a corresponding CSS is referred to as Type3-PDCCH CSS.

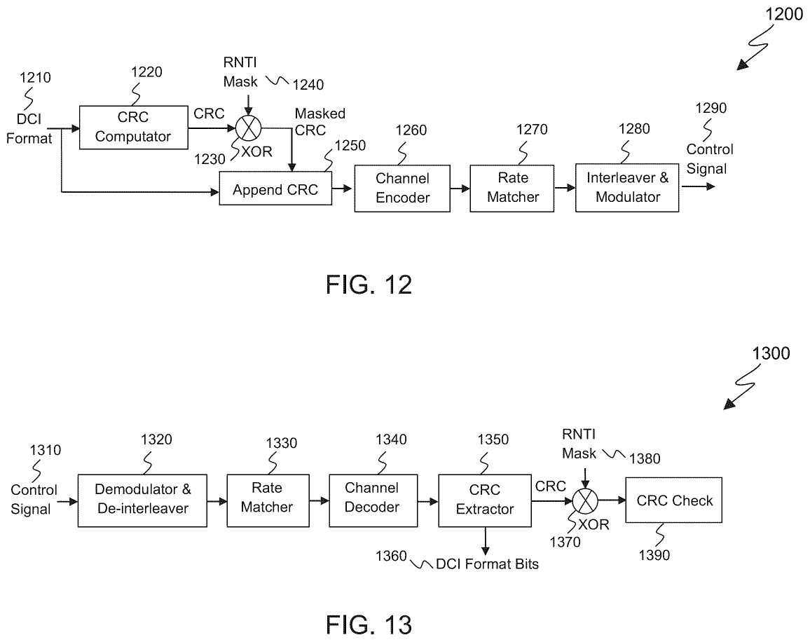

FIG. 12 illustrates an example of a transmitter structure 1200 for a PDCCH according to embodiments of the present disclosure. For example, transmitter structure 1200 may be implemented by a gNB 102 of FIG. 1. This example is for illustration only and other embodiments can be used without departing from the scope of the present disclosure.

As illustrated in FIG. 12, a gNB separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 16 bits or 24 bits and the RNTI can include 16 bits or 24 bits. Otherwise, when a RNTI is not included in a DCI format, a DCI format type indicator field can be included in the DCI format. The CRC of (non-coded) DCI format bits 1210 is determined using a CRC computation unit 1220, and the CRC is masked using an exclusive OR (XOR) operation unit 1230 between CRC bits and RNTI bits 1240. The XOR operation is defined as XOR(0,0)=0, XOR(0,1)=1, XOR(1,0)=1, XOR(1,1)=0. The masked CRC bits are appended to DCI format information bits using a CRC append unit 1250. An encoder 1260 performs channel coding (such as tail-biting convolutional coding or polar coding), followed by rate matching to allocated resources by rate matcher 1270. Interleaving and modulation units 1280 apply interleaving and modulation, such as QPSK, and the output control signal 1290 is transmitted.

FIG. 13 illustrates an example of a receiver structure 1300 for a PDCCH according to embodiments of the present disclosure. For example, receiver structure 1300 may be implemented by any of the UEs 111-116 of FIG. 1. This example is for illustration only and other embodiments can be used without departing from the scope of the present disclosure.

As illustrated in FIG. 13, a received control signal 1310 is demodulated and de-interleaved by a demodulator and a de-interleaver 1320. A rate matching applied at a gNB transmitter is restored by rate matcher 1330, and resulting bits are decoded by decoder 1340. After decoding, a CRC extractor 1350 extracts CRC bits and provides DCI format information bits 1360. The DCI format information bits are de-masked 1370 by an XOR operation with a RNTI 1380 (when applicable) and a CRC check is performed by unit 1390. When the CRC check succeeds (checksum is zero), the DCI format information bits are considered to be valid. When the CRC check does not succeed, the DCI format information bits are considered to be invalid.

A PDCCH transmission can be within a set of PRBs. A gNB can configure a UE one or more sets of PRB sets, also referred to as control resource sets (CORESETs), for PDCCH receptions as described in [3]. A PDCCH reception can be in control channel elements (CCEs) that are included in a CORESET. A UE can monitor PDCCH according to a first PDCCH monitoring type or according to a second PDCCH monitoring type. For the first PDCCH monitoring type, a maximum number of PDCCH candidates M_{PDCCH}^{max,slot,μ} and a maximum number of non-overlapping CCEs C_{PDCCH}^{max,slot,μ} for the reception of PDCCH candidates is defined per slot. Non-overlapping CCEs are CCEs with different indexes or in different symbols of a CORESET or in different CORESETs.

If a UE can support a first set of N_{cells,0}^{DL}, serving cells where the UE is either not provided CORESETPoolIndex or is provided CORESETPoolIndex with a single value for all CORESETs on all DL BWPs of each serving cell from the first set of serving cells, and a second set of N_{cells,1}^{DL} serving cells where the UE is provided CORESETPoolIndex with a value 0 for a first CORESET and with a value 1 for a second CORESET on any DL BWP of each serving cell from the second set of serving cells, the UE determines, for the purpose of reporting pdcch-BlindDetectionCA, a number of serving cells as N_{cells,0}^{DL}+R·N_{cells,1}^{DL} where R is a value reported by the UE.

If a UE is configured with N_{cells,0}^{DL,μ}+N_{cells,1}^{DL,μ} downlink cells, with associated PDCCH candidates monitored in the active DL BWPs of the scheduling cell(s) using SCS configuration μ, where Σ_{μ=0}³(N_{cells,0}^{DL,μ}+γ·N_{cells,0}^{DL,μ})>N_{cells}^{cap}, and a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDDCH}^{total,slot,μ}=└N_{cells}^{cap}·M_{PDDCH}^{max,slot,μ}·(N_{cells,0}^{DL,μ}+β·N_{cells,1}^{DL,μ})/Σⱼ₌₀³(N_{cells,0}^{DL,j}+γ·N_{cells,1}^{DL,j})┘ PDCCH candidates or more than C_{PDDCH}^{total,slot,μ}=└N_{cells}^{cap}·C_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ non-overlapped CCEs per slot on the active DL BWP(s) of scheduling cell(s) from the N_{cells,0}^{DL,μ}+N_{cells,1}^{DL,μ} downlink cells, where N_{cells}^{cap} is either equal to 4 or is a capability reported by the UE, and γ is a value that is either provided by higher layers to the UE or, otherwise, γ=R.

For each scheduled cell, the UE is not required to monitor on the active DL BWP with SCS configuration μ of the scheduling cell from the N_{cells,0}^{DL,μ} downlink cells more than min(M_{PDDCH}^{max,slot,μ},M_{PDCCH}^{total,slot,μ}) PDCCH candidates or more than min(C_{PDDCH}^{max,slot,μ},C_{PDCCH}^{total,slot,μ}) non-overlapped CCEs per slot.

For each scheduled cell, the UE is not required to monitor on the active DL BWP with SCS configuration μ of the scheduling cell from the N_{cells,1}^{DL,μ} downlink cells more than min(γ·M_{PDCCH}^{max,slot,μ},M_{PDCCH}^{total,slot,μ}) PDCCH candidates or more than min(γ·C_{PDCCH}^{max,slot,μ},C_{PDCCH}^{total,slot,μ}) non-overlapped CCEs per slot, more than min(M_{PDCCH}^{max,slot,μ},M_{PDCCH}^{total,slot,μ}) PDCCH candidates or more than min(C_{PDCCH}^{max,slot,μ},C_{PDCCH}^{total,slot,μ} non-overlapped CCEs per slot for CORESETs with same CORESETPoolIndex value.

If a CORESETPoolIndex is not provided for a cell or if a single CORESETPoolIndex is provided for a cell, then γ=0.

A UE determines CCEs for decoding a PDCCH candidate based on a search space as described in [3]. For some RNTIs, such as a C-RNTI, a set of PDCCH candidates for respective DCI formats defines corresponding UE-specific search space sets (USS sets) as described in [3] and [6]. For other RNTIs, such as a SI-RNTI, a set of PDCCH candidates for respective DCI formats defines corresponding common search space sets (CSS sets). A search space set is associated with a CORESET where the UE monitors PDCCH candidates for the search space set. A UE expects to monitor PDCCH candidates for up to 4 sizes of DCI formats that include up to 3 sizes of DCI formats with CRC scrambled by C-RNTI or MCS-C-RNTI per serving cell. The UE counts a number of sizes for DCI formats per serving cell based on a number of configured PDCCH candidates in respective search space sets for the corresponding active DL BWP.

For cross-carrier scheduling, the number of PDCCH candidates for monitoring and the number of non-overlapped CCEs per span or per slot are separately counted for each scheduled cell.

For a search space set s associated with CORESET p, the CCE indexes for aggregation level L corresponding to PDCCH candidate m_{s,n}_{_{Cl}} of the search space set in slot n_{s,f}^{μ} for an active DL BWP of a serving cell corresponding to carrier indicator field value n_{Cl} are given by

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

where for any

$$CSS , {Y}_{p , {n}_{s , f}^{μ}} = 0 ;$$

### for a USS,

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, and D=65537; i=0, . . . , L−1; N_{CCE,p} is a number of CCEs, numbered from 0 to N_{CCE,p}−1, in CORESET p; n_{Cl} is a carrier indicator field value if the UE is configured with a carrier indicator field for the serving cell on which PDCCH is monitored; otherwise, including for any CSS, n_{Cl}=0;m_{s,n}_{_{Cl}}=0, . . . , M_{s,n}_{_{Cl}}^{(L)}−1, where M_{s,n}_{_{Cl}}^{(L)} is the number of PDCCH candidates the UE is configured to monitor for aggregation level L of a search space set s for a serving cell corresponding to n_{Cl}; for any CSS, M_{s,max}^{(L)}=M_{s,0}^{(L)}; for a USS, M_{s,max}^{(L)} is the maximum of M_{s,n}_{_{Cl}}^{(L)} over all configured n_{Cl} values for a CCE aggregation level L of search space set s; the RNTI value used for n_{RNTI} is the C-RNTI.

A UE monitors PDCCH according to a CSS for scheduling a PDSCH providing system information, random access response, or paging only on one cell that is referred to as primary cell. The UE transmits PUCCH only on the primary cell. The UE can also be configured a primary secondary cell (PSCell) for PUCCH transmissions and then the UE transmits PUCCH on the primary cell for a master/primary cell group and transmits PUCCH on the PSCell for a secondary cell group. For brevity and descriptive conciseness, this disclosure considers examples for a primary cell, but the embodiments may be applied to a PSCell.

For all search space sets within a slot n or within a span in slot n, denote by S_{css} a set of CSS sets with cardinality of I_{css} and by Sᵤₛₛ a set of USS sets with cardinality of J_{css}. The location of USS sets sⱼ, 0≤j<Jᵤₛₛ, in Sᵤₛₛ is according to an ascending order of the search space set index.

Denote by M_{S}_{_{css}}₍ᵢ₎^{(L)}, 0≤i<I_{css}, the number of counted PDCCH candidates for monitoring for CSS set S_{css}(i) and by M_{S}_{ᵤₛₛ}₍ⱼ₎^{(L)}, 0≤j<Jᵤₛₛ, the number of counted PDCCH candidates for monitoring for USS set Sᵤₛₛ(j). For the CSS sets, a UE monitors M_{PDCCH}^{CSS}=Σᵢ₌₀^{I}^{_{css}}⁻¹Σ_{L} M_{S}_{_{css}}₍ᵢ₎^{(L)} PDCCH candidates requiring a total of C_{PDCCH}^{CSS} non-overlapping CCEs in a slot or in a span.

The UE allocates PDCCH candidates for monitoring to USS sets for the primary cell having an active DL BWP with SCS configuration μ in a slot according to the following pseudocode. If for the USS sets for scheduling on the primary cell the UE is not provided CORESETPoolIndex for first CORESETs or is provided CORESETPoolIndex with value 0 for first CORESETs, and is provided CORESETPoolIndex with value 1 for second CORESETs, and if min(γM_{PDCCH}^{max,slot,μ},M_{PDCCH}^{total,slot,μ})>min(M_{PDCCH}^{max,slot,μ},M_{PDCCH}^{total,slot,μ}) or min(γ·C_{PDCCH}^{max,slot,μ},C_{PDCCH}^{total,slot,μ})>min(C_{PDCCH}^{max,slot,μ},C_{PDCCH}^{total,slot,μ}), the following pseudocode applies only to USS sets associated with the first CORESETs. A UE does not expect to monitor PDCCH in a USS set without allocated PDCCH candidates for monitoring.

Denote by V_{CCE}(Sᵤₛₛ(j)) the set of non-overlapping CCEs for search space set Sᵤₛₛ(j) and by C(V_{CCE}(Sᵤₛₛ(j))) the cardinality of V_{CCE}(Sᵤₛₛ(j)) where the non-overlapping CCEs for search space set Sᵤₛₛ(j) are determined considering the allocated PDCCH candidates for monitoring for the CSS sets and the allocated PDCCH candidates for monitoring for all search space sets Sᵤₛₛ(k), 0≤k≤j. Set M_{PDCCH}^{uss}=min(M_{PDCCH}^{max,slot,μ},M_{PDCCH}^{total,slot,μ})−M_{PDCCH}^{css}. Set C_{PDCCH}^{uss}=min(C_{PDCCH}^{max,slot,μ},C_{PDCCH}^{total,slot,μ})−_{PDCCH}^{css}. Set j=0. While Σ_{L} M_{S}_{ᵤₛₛ}₍ⱼ₎^{(L)}≤M_{PDCCH}^{uss} AND C(V_{CCE}(Sᵤₛₛ(j)))≤C_{PDCCH}^{uss} allocate Σ_{L} M_{S}_{ᵤₛₛ}₍ⱼ₎^{(L)} PDCCH candidates for monitoring to USS set Sᵤₛₛ(j). Determine M_{PDCCH}^{uss}=M_{PDCCH}^{uss}−Σ_{L} M_{S}_{ᵤₛₛ}₍ⱼ₎^{(L)}; C_{PDCCH}^{uss}=C_{PDCCH}^{uss}−C(V_{CEE}(Sᵤₛₛ(j))); j+1; then the while loop ends.

An ability of a gNB to schedule a UE on a cell depends on a maximum PDCCH monitoring capability of the UE for scheduling on the cell as defined by min(M_{PDCCH}^{max,slot,μ},M_{PDCCH}^{total,slot,μ}) PDCCH candidates and min(C_{PDCCH}^{max,slot,μ},C_{PDCCH}^{total,slot,μ}) non-overlapped CCEs per slot for a scheduling cell from the N_{cells,0}^{DL,μ} downlink cells or by min(γ·M_{PDCCH}^{max,slot,μ},M_{PDCCH}^{total,slot,μ}) PDCCH candidates and min(γ·C_{PDCCH}^{max,slot,μ},C_{PDCCH}^{total,slot,μ}) for a scheduling cell from the N_{cells,1}^{DL,μ} downlink cells. While M_{PDCCH}^{max,slot,μ} and C_{PDCCH}^{max,slot,μ} are predetermined numbers for a SCS configuration μ, M_{PDCCH}^{total,slot,μ} and C_{PDCCH}^{total,slot,μ} are variable and depend on a total number of cells for SCS configuration μ, N_{cells,0}^{DL,μ}+γ·N_{cells,1}^{DL,μ}, and on a total number of cells across all SCS configurations Σⱼ₌₀³(N_{cells,0}^{DL,μ}+γ·N_{cells,1}^{DL,μ}). Determining M_{PDCCH}^{total,slot,μ} and C_{PDCCH}^{total,slot,μ} based on a number of configured cells results to an under-dimensioning of the PDCCH monitoring capability of the UE as, at a given time, the UE can deterministically know that it cannot be scheduled in certain cells and therefore a corresponding PDCCH monitoring capability can be reallocated to other cells where scheduling can occur.

Embodiments of the present disclosure recognize that using Rel-15 NR, the PDCCH monitoring activity of the UE in RRC_CONNECTED mode may be controlled in several ways by a serving gNB using higher layer signaling through bandwidth part (BWP) adaptation, or discontinuous reception (DRX) as described in [3], [5], and [6]. Note that DRX for UEs in RRC_CONNECTED mode may also be referred to as C-DRX operation.

Embodiments of the present disclosure recognize that using Rel-15 NR and when a gNB configures BWP adaptation to a UE, the gNB may set transmission and reception bandwidths for the UE to be smaller than the NR carrier bandwidth. Up to 4 DL or UL BWPs may be configured for a UE. For operation in unpaired spectrum, i.e., TDD, a DL BWP and UL BWP in a DL/UL BWP pair have a same center frequency. A UE has only one active DL BWP for receptions and only one active UL BWP for transmissions at any given time. A UE monitors PDCCH on the one active DL BWP i.e., the UE does not have to monitor PDCCH on the entire DL frequency of the cell or on configured DL BWPs that are not active. A BWP inactivity timer or counter (independent from the DRX inactivity timer) may be used for a UE to switch an active DL BWP to a default DL BWP when multiple DL BWPs are available for the UE. The UE restarts the BWP inactivity timer or counter upon successful decoding of a DCI format and the change to the default DL BWP occurs when the timer or counter expires as described in [3].

Embodiments of the present disclosure recognize that using Rel-15 NR and when a UE operates with DRX, the UE is not required to continuously monitor the PDCCH on the active BWP. DRX operation in RRC_CONNECTED mode (C-DRX) is based on the use of a configurable DRX cycle for the UE. When a DRX cycle is configured, the UE monitors PDCCH only during the active time. The UE does not need to monitor PDCCH and can switch off receiver circuitry during certain periods of the inactivity time. That operation reduces UE power consumption. The longer the DRX inactive time, the lower the UE power consumption but the larger the latency for scheduling the UE as the gNB scheduler can only reach the UE when the UE is active according to its DRX cycle. Typically, if the UE has been scheduled and is receiving or transmitting data, the UE is likely to be frequently scheduled and waiting until the next activity period according to the DRX cycle would result in additional delays. Therefore, to reduce or avoid such delays, the UE remains in the active state for a configurable time period after being scheduled. That is realized by a DRX inactivity timer that the UE starts every time the UE is scheduled, and the UE remains awake until the timer expires.

The NR HARQ retransmissions are asynchronous in both DL and UL. If the UE receives a first PDSCH providing a TB for a HARQ process that the UE cannot correctly decode, a typical gNB behavior is to transmit a second PDSCH providing the TB for the HARQ process at a later time. The DRX scheme provides a configurable timer or counter that the UE starts after an incorrect TB reception and the timer or counter is used to wake up the UE receiver when the gNB may schedule the second PDSCH. The value of the timer or counter is preferably set to match the (implementation specific) HARQ RTT. For some services such as VoIP characterized by periods of regular transmission, followed by periods of no activity, a second (short) DRX cycle can be optionally configured in addition to the long DRX cycle.

With reference to the Rel-15 NR DRX procedures, embodiments of the present disclosure recognize that using when the UE is not in active time during an OFDM symbol, the UE does not transmit periodic or semi-persistent SRS and does not report CSI on PUCCH or semi-persistent CSI on PUSCH. However, regardless of whether or not the UE monitors PDCCH on serving cells in a DRX group during the C-DRX operation, the UE transmits HARQ feedback, aperiodic CSI on PUSCH, and aperiodic SRS on the serving cells in the DRX group when such transmissions are expected. In addition, the UE may be configured with a CSI Mask to limit the transmission of CSI reports to the on-duration period of the DRX cycle using the parameter csi-Mask in MAC-CellGroupConfig. A DRX on-duration for a UE is the time interval during which the UE expects to receive PDCCH. If the UE successfully decodes DCI provided by the PDCCH, the UE remains awake and starts a DRX inactivity timer. The DRX inactivity timer is a time interval during which the UE waits for successful decoding of DCI provided by PDCCHs, starting from a last successful decoding of DCI in a PDCCH. If the UE does not correctly decode any DCI when the DRX inactivity timer is running, the UE can go to sleep and skip receptions. The UE restarts the inactivity timer following a single successful decoding of DCI in a PDCCH only for a first transmission of a TB, i.e., not for retransmissions of a TB. A DRX retransmission-timer is a time interval until a UE can expect a retransmission of a TB. A DRX cycle specifies the periodic repetition of the on-duration followed by a possible period of inactivity. DRX active time is the total time duration that the UE monitors PDCCH. This includes the on-duration of the DRX cycle, the time that the UE is performing continuous reception while the inactivity timer is running, and the time when the UE is performing continuous reception while awaiting a TB retransmission. The UE MAC entity needs not to monitor PDCCH if the PDCCH monitoring occasion is not complete, e.g., when the active time starts or ends in the middle of a PDCCH monitoring occasion.

The UE MAC entity may be configured by higher layers, i.e. RRC, with a DRX functionality that controls the UE's PDCCH monitoring activity for a number of RNTIs for the MAC entities as described in [5]. For example, RRC may control the DRX operation of the UE in RRC_CONNECTED mode by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new UL/DL transmission for the MAC entity;
drx-RetransmissionTimerDL (per-DL HARQ process except for the broadcast process): the maximum duration until a DL retransmission is received;
drx-RetransmissionTimerUL (per-UL HARQ process): the maximum duration until a grant for UL retransmission is received;
drx-LongCycleStartOffset: the long DRX cycle and drx-StartOffset which define the subframe where the long and short DRX cycle starts;
drx-ShortCycle (optional): the short DRX cycle;
drx-ShortCycleTimer (optional): the duration in which the UE follows the short DRX cycle;
drx-HARQ-RTT-TimerDL (per-DL HARQ process except for the broadcast process): the minimum duration before the MAC entity expects a DL assignment for HARQ retransmission;
drx-HARQ-RTT-TimerUL (per-UL HARQ process): the minimum duration before the MAC entity expects an UL HARQ retransmission grant.

For example, the triggering condition or timing for a DRX cycle is: [(SFN×10)+subframe number] mod (drx-ShortCycle)=(drx-StartOffset) mod (drx-ShortCycle).

If a Short DRX cycle is configured, the ‘on duration’ period starts at a subframe satisfying the above condition. Within the calculated subframe, the actual ‘on duration’ starts after a certain slot offset which is determined by drx-SlotOffset. Upon the expiry of drx-ShortCycleTimer, or if Short DRX cycle is not configured, the UE uses the Long DRX cycle with the following triggering condition for the start of ‘on duration’ period where the actual ‘on duration’ starts after a certain slot offset which is determined by drx-SlotOffset. [(SFN×10)+subframe number] mod (drx-LongCycle)=(drx-StartOffset).

When the gNB knows that there is no additional data for the UE in the gNB buffer, the gNB can use MAC CE to indicate to the UE to terminate the ongoing active state and enter inactive state. In Rel-15 NR, two MAC CEs can be used. The DRX Command MAC CE using MAC sub-header with LCID=60 forces the UE to terminate the current active time and enter the regular DRX cycle. Upon reception, the UE comes out of DRX active state and enters DRX inactive state. The UE enters Short DRX cycle if Short DRX Cycle is configured; else the UE enters the Long DRX cycle. When a DRX related MAC CE is received by the UE, the UE applies the corresponding procedure to both the default DRX group and the secondary DRX group. The Long DRX Command MAC CE using MAC sub-header with LCID=59 forces the UE to terminate the current active time and enter the Long DRX cycle. The UE enters Long DRX cycle even if the Short DRX cycle is configured. For example, this may be useful if the gNB determines that there would not be any data that would require the Short DRX cycle to be used.

When SPS PDSCH receptions or CG PUSCH transmissions are configured for the UE, the following procedures may apply. For scheduling retransmissions of a TB provided by SPS PDSCH, the DCI format 1_0/1_1 may use the Configured Scheduling-RNTI (CS-RNTI). If a MAC PDU is received, the UE starts the drx-HARQ-RTT-TimerDL in the first symbol after transmitting a PUCCH with NACK for the TB. Once drx-HARQ-RTT-TimerDL timer expires, the UE starts the drx-RetransmissionTimerDL timer in the next symbol and becomes active for this duration of this timer. For CG PUSCH, when the UE transmits a MAC PDU, the re-transmission handling for a corresponding TB is similar to that of TBs scheduled by DCI. If a MAC PDU is transmitted on a CG-PUSCH, the UE starts the timer drx-HARQ-RTT-TimerUL in the immediate first symbol after transmitting PUSCH. If PUSCH repetition is configured, then the UE starts the timer after the first PUSCH transmission within a bundle. When the drx-HARQ-RTT-TimerUL timer expires, the UE starts drx-RetransmissionTimerUL timer in the next symbol and becomes active for this duration of this timer to receive re-transmission request(s) from the gNB.

Embodiments of the present disclosure recognize that using Rel-16 NR, a configuration of DRX related parameters for a second DRX group using parameter drx-ConfigSecondaryGroup-r16 can be supported. All serving cells in the secondary DRX group then belong to one frequency range (FR) and all serving cells in the default DRX group belong to another FR. The network configures only drx-InactivityTimer and drx-onDurationTimer as part of this configuration. The network therefore has the flexibility to control ‘on duration’ and ‘inactivity time’ per serving cell. When the second DRX group is configured, the drx-InactivityTimer and drx-onDurationTimer values for the second DRX group are smaller than the respective values configured for the default DRX group in IE DRX-Config. When parameter drx-ConfigSecondaryGroup-r16 is configured, the gNB can indicate the serving cells that belong to the secondary group using the IE SCellConfig. If no indication is provided, an SCell belongs to the default DRX group.

Embodiments of the present disclosure recognize that using Rel-16 and/or Rel-17 NR, the PDCCH monitoring activity of the UE can be further controlled by several additional features such as the UE power savings feature using DCI format 2_6 with CRC scrambled by PS-RNTI (DCP), or such as the PDCCH monitoring adaptation feature based on PDCCH skipping and search space set group (SSSG) switching as described in [3].

Embodiments of the present disclosure recognize that Rel-16 NR provides additional features to reduce UE power consumption for UE in RRC_CONNECTED mode such as DCI with CRC scrambled by PS-RNTI (DCP), cross-slot scheduling, or MIMO layer adaptation features. The UE may provide assistance information to the gNB to indicate its preferred radio or protocol configurations, such as its preferred C-DRX configuration, aggregated bandwidth, SCell configuration, MIMO configuration, configuration parameters for an RRC state, or minimum scheduling offset values, for a gNB or network to select a UE radio or UE protocol configuration.

Embodiments of the present disclosure recognize that using Rel-16 NR, when a UE is configured to monitor PDCCH associated with a DCI format 2_6 with CRC scrambled by PS-RNTI (DCP), the UE may be indicated by the DCP whether or not the UE is required to monitor PDCCH on the PCell during a next occurrence of the on-duration of the UE's C-DRX cycle. If the UE does not detect a DCP on the active BWP prior to a next on-duration, the UE does not monitor PDCCH during the next on-duration unless the UE is explicitly indicated by the gNB via prior higher signaling to monitor PDCCH in that case. The DCP feature using DCI format 26 may also provide SCell dormancy indication in case the UE has activated SCells. A UE can only be configured to monitor DCP when DRX in RRC_CONNECTED mode (C-DRX) is configured, and at one or more monitoring occasions located at configured offsets before the DRX on-duration. The UE does not monitor DCP on occasions occurring during active time, measurement gaps, BWP switching, or when the UE monitors response for a CFRA preamble transmission for beam failure recovery. If a UE is not configured to monitor PDCCH for DCP, the UE follows normal DRX operation. When the UE operates with CA, the UE may monitor PDCCH for DCP only on the PCell. One DCP can control PDCCH monitoring during a DRX on-duration for one or more UEs independently.

For example, the UE may be configured by higher layers, i.e. RRC, with one or more parameters to adjust or control the UE monitoring behavior for reception of PDCCH associated with a DCI format 2_6:
ps-RNTI: the RNTI value for scrambling CRC of DCI format 2-6 used for power saving;
ps-Offset: the start of the search-time of DCI format 2-6 with CRC scrambled by PS-RNTI relative to the start of the drx-onDurationTimer of Long DRX and where a value is in multiples of 0.125 msec;
ps-WakeUp: indicates the UE to wake-up if DCI format 2-6 is not detected outside active time (if absent, the UE does not wake-up if DCI format 2-6 is not detected outside active time);
ps-PositionDCI-2-6: starting position of UE wakeup and SCell dormancy indication in DCI format 2-6;
ps-TransmitPeriodicL1-RSRP: indicates the UE to transmit periodic L1-RSRP report(s) when the drx-onDurationTimer does not start (if absent, the UE does not transmit periodic L1-RSRP report(s) when the drx-onDurationTimer does not start)
ps-TransmitOtherPeriodicCSI: indicates the UE to transmit periodic CSI report(s) other than L1-RSRP reports when the drx-onDurationTimer does not start (if absent, the UE does not transmit periodic CSI report(s) other than L1-RSRP reports when the drx-onDurationTimer does not start).

Embodiments of the present disclosure recognize that with reference to the Rel-16 NR procedures for monitoring DCI format 2_6 (DCP), a UE can be configured to monitor PDCCH on a primary cell outside active time for detection of a DCI format 2_6 and a location of a wake-up indication bit in the DCI format 2_6. A ‘0’ value for the wake-up indication bit, when reported to higher layers, indicates to not start the drx-onDurationTimer for the next long DRX cycle. A ‘1’ value for the wake-up indication bit, when reported to higher layers, indicates to start the drx-onDurationTimer for the next long DRX cycle. When the UE is configured search space sets to monitor PDCCH for detection of a DCI format 2_6 and the UE fails to detect the DCI format 2_6, the UE behavior for whether or not the UE starts the drx-onDurationTimer for the next DRX cycle on the primary cell can be configured by higher layers, i.e., to start the drx-onDurationTimer or to not start the drx-onDurationTimer. When a UE detects DCI format 2_6, the physical layer of a UE reports the value of the wake-up indication bit for the UE to higher layers for the next long DRX cycle; otherwise, it does not.

For example, the following information is transmitted by means of the DCI format 2_6 with CRC scrambled by PS-RNTI: block number 1, block number 2, . . . , block number N where the starting position of a block is determined by the parameter ps-PositionDCI-2-6 provided to the UE configured with the block by higher layers. If the UE is configured with higher layer parameter ps-RNTI and dci-Format2-6, one block is configured for the UE by higher layers, with the following fields defined for the block: a Wake-up indication field of length 1 bit and/or an SCell dormancy indication field of length 0 bit if higher layer parameter dormancyGroupOutsideActiveTime is not configured; otherwise 1, 2, 3, 4 or 5 bits bitmap determined according to the number of different DormancyGroupID(s) provided by higher layer parameter dormancyGroupOutsideActiveTime, where each bit corresponds to one of the SCell group(s) configured by higher layers parameter dormancyGroupOutsideActiveTime, with MSB to LSB of the bitmap corresponding to the first to last configured SCell group in ascending order of DormancyGroupID. The size of DCI format 2_6 is indicated by the higher layer parameter sizeDCI-2-6 as described in [3].

The UE can be provided with an offset by parameter ps-Offset indicating a time, where the UE starts monitoring PDCCH for detection of DCI format 2_6 according to the number of search space sets, prior to a slot where the drx-onDurationTimer would start on the PCell or on the SpCell. For each search space set, the PDCCH monitoring occasions are the ones in the first Tₛ slots indicated by parameter duration, or Tₛ slots=1 slot if duration is not provided, starting from the first slot of the first Tₛ slots and ending prior to the start of drx-onDurationTimer. If a UE reports for an active DL BWP a MinTimeGap value that is X slots prior to the beginning of a slot where the UE would start the drx-onDurationTimer, the UE is not required to monitor PDCCH for detection of DCI format 26 during the X slots, where X corresponds to the MinTimeGap value of the SCS of the active DL BWP as described in [3].

When the UE is configured in DCI format 2_6 a bitmap for corresponding groups of configured SCells, a ‘0’ value for a bit of the bitmap indicates an active DL BWP that is a dormant BWP for the UE for each activated SCell in the corresponding group of configured SCells. A ‘1’ value for a bit of the bitmap indicates an active (non-dormant) DL BWP for the UE for each activated SCell in the corresponding group of configured SCells, if a current active DL BWP is the dormant DL BWP, or a current active DL BWP for the UE for each activated SCell in the corresponding group of configured SCells if the current active DL BWP is not the dormant DL BWP. The UE does not monitor PDCCH in the dormant BWP of an SCell. The UE can also be indicated to change an active DL BWP to a dormant BWP or to a non-dormant BWP by a DCI format scheduling PDSCH reception on the primary cell as described in [2] and [3] and the corresponding descriptions are omitted in this disclosure for brevity. An active DL BWP of a UE on a primary cell is not indicated to change to a dormant BWP.

On PDCCH monitoring occasions associated with a same long DRX cycle, a UE does not expect to detect more than one DCI format 2_6 with different values of the wake-up indication bit for the UE or with different values of the bitmap for the UE. The UE does not monitor PDCCH for detecting DCI format 2_6 during active time.

Rel-17 NR provides additional features in support of reduced UE power consumption for UEs in RRC_IDLE/RRC_INACTIVE or in RRC_CONNECTED modes such as paging enhancements for UEs in RRC_IDLE/RRC_INACTIVE modes, the provision of potential TRS/CSI-RS occasions available in RRC_CONNECTED mode to UEs in RRC_IDLE/RRC_INACTIVE modes, or PDCCH monitoring reduction features including SSSG switching or PDCCH skipping for UEs in RRC_CONNECTED mode, or relaxation of UE measurements for RLM and/or BFD for UEs in RRC_CONNECTED mode.

Using Rel-17 NR, when a UE is configured with a PDCCH monitoring reduction feature, PDCCH monitoring by the UE can be adapted by the gNB for Type3-PDCCH CSS sets or USS sets on the active DL BWP of the serving cell. For example, as described in [3], an adaptation can be triggered using a PDCCH monitoring adaptation indication field in DCI formats 0_1/0_2/1_1/1_2.

For example, SSSG switching may be configured using a Rel-17 configuration of SSSGs provided by higher layers. The UE can be indicated to switch from a first SSSG to a second SSSG for PDCCH monitoring via an indication by a scheduling DCI. If a SSSG switch timer is also configured, the UE switches to the SSSG with lowest group index (e.g. group index 0) after timer expiration if the UE does not detect any DCI format with CRC scrambled by C-RNTI/CS-RNTI/MCS-C-RNTI during the configured timer duration. The associated switching delay is at least P_{switch} symbols, where P_{switch} depends on the numerology of the active DL BWP for the UE on the serving cell as described in [3]. The UE can be configured with up to 3 SSSGs.

For example, PDCCH skipping mechanism may be configured for a UE. A configuration for a set of PDCCH skipping durations is provided to a UE by higher layers. A UE can be indicated to skip PDCCH monitoring for a duration from the set of durations, starting from a next slot after the slot of the PDCCH reception that provides the DCI format with the indication. A UE resumes PDCCH monitoring after the duration. The UE ignores an indication for PDCCH skipping and continues to monitor PDCCH in several cases, for example as described in [3]. For example, one such case is when the UE transmitted a PUCCH with positive SR and has not received a DCI format scheduling a PUSCH transmission. Another such case is when a contention resolution timer is running or during monitoring of the RAR/MsgB window on an SpCell. Several additional cases can exist and are not captured for brevity.

A UE can be configured for both SSSG switching and PDCCH skipping. In such case, the UE performs either SSSG switching or PDCCH skipping based on the indication by the PDCCH monitoring adaptation indication field in a DCI format 0_1/0_2/1_1/1_2 that can indicate either PDCCH skipping or SSSG switching as described in [3].

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=19 for Rel-19, or xx=20 for Rel-20, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [3].

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

Various embodiments of present disclosure provide UE procedures for enabling adaptation to monitoring of PDCCHs via PDCCH monitoring indication or indication of dormancy/non-dormancy for SCells in FD systems in order to improve system operation according to channel conditions or to reduce UE modem complexity or to provide UE power savings.

In certain embodiments, a UE may be provided with an SBFD configuration based on a parameter sbfd-config to determine receptions and/or transmissions on a serving cell supporting full-duplex operation. For example, the UE may be provided with a set of RBs or a set of symbols for an SBFD UL or DL subband on a symbol or in a slot based on sbfd-config. For example, the UE may be provided with a set of symbols or slots for an SBFD subband based on sbfd-config. An SBFD configuration may be provided by higher layers, e.g., RRC, or may be indicated based on DCI and/or MAC-CE signaling. A combination of SBFD configuration based on higher layer parameters such as sbfd-config and indication through DCI and/or MAC-CE signaling may also be used. The UE may determine an SBFD configuration for a symbol or a slot or a set of symbols or a set of slots using higher layer parameters provided for an SBFD configuration and based on reception or transmission conditions such as a slot type ‘D’, ‘U’, or ‘F’. In one example, the SBFD configuration and/or parameters associated with the SBFD configuration are same for all TRPs. In one example, the SBFD configuration and/or parameters associated with the SBFD configuration can be TRP specific following the aforementioned configuration examples.

For example, an SBFD configuration may provide a set of time-domain resources, e.g., symbols/slots, where receptions or transmissions by the UE are allowed, possible, or disallowed. An SBFD configuration may provide a range or a set of frequency-domain resources, e.g., serving cell, BWP, start and/or end or a set of RBs, where receptions or transmissions by the UE are allowed, possible, or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as ‘non-SBFD symbol’ or ‘SBFD symbol’, or ‘simultaneous Tx-Rx’, ‘Rx only’, ‘Tx only’ or ‘D’, ‘U’, ‘F’, ‘N/A’. An SBFD configuration may be associated with one or multiple scheduling behaviors, e.g., for “dynamic grant”, for “configured grant”, for “any”. An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB, or to determine the power and/or spatial settings for transmissions by the UE.

For example, a UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot (frequency domain resources). For example, the UE may be provided with a set of symbols or slots for an SBFD subband (time domain resources). In one example, the SBFD configuration applies to all TRPs in the cell. In one example, the SBFD configurations are separately provided for each TRP in the cell. In one example, a common SBFD configuration is provided for a cell and an additional delta configuration is separately provided for each TRP in the cell, wherein the delta configuration can include additional frequency/time domain resources to be added to the common configuration and/or excluded frequency/time domain resources to be excluded from the common configuration. In one example, the SBFD configurations are separately provided for each TRP in the cell. In one example, a common SBFD configuration is provided for a first TRP of the cell and an additional delta configuration is provided for each other TRP in the cell, wherein the delta configuration can include additional frequency/time domain resources to be added to the common configuration and/or excluded frequency/time domain resources to be excluded from the common configuration.

For example, an SBFD configuration and/or parameters associated with SBFD configuration based on sbfd-config may be provided by higher layer, e.g., RRC, or may be indicated based on DCI and/or MAC-CE signaling. A combination of SBFD configuration and/or parameterization based on higher layer parameters and indication through DCI and/or MAC-CE signaling may be used. The UE may determine an SBFD configuration for a symbol or a slot or a set of symbols or a set of slots using higher layer parameters provided for an SBFD configuration and based on reception or transmission conditions such as for a slot or symbol type ‘D’, ‘U’, or ‘F or a slot or a symbol type ‘SBFD’ or ‘non-SBFD’ or for an SBFD subband type such as ‘SBFD DL subband’, ‘SBFD UL subband’, or ‘SBFD Flexible subband’.

For example, an SBFD configuration may provide a set of time-domain resources, e.g., symbols/slots, where receptions or transmissions by the UE are allowed, possible, or disallowed. In one example, the time-domain resources are same (e.g., common) for all TRPs as aforementioned. In another example, the time-domain resources can be different for each TRP, as aforementioned. An SBFD configuration may provide a range or a set of frequency-domain resources, e.g., serving cell, BWP, start and/or end or a set of RBs, where receptions or transmissions by the UE are allowed, possible, or disallowed. In one example, the frequency-domain resources are same (e.g., common) to all TRPs as aforementioned. In another example, the frequency-domain resources can be different for each TRP, as aforementioned. An SBFD configuration may provide one or multiple guard intervals or guard RBs for time and/or frequency domain radio resources during receptions or transmissions by the UE, e.g., guard SCs or RBs, guard symbols, wherein the provided SBFD configuration may be same or different for each TRP as aforementioned. An SBFD configuration may be provided based on one or multiple resource types such as non-SBFD symbol’ or ‘SBFD symbol’, or ‘simultaneous Tx-Rx’, ‘Rx only’, ‘Tx only’ or ‘D’, ‘U’, ‘F’, ‘N/A’. In one example, SBFD configuration is performed at a slot level. In one example, SBFD configuration is performed at a symbol level. In one example, SBFD configuration is performed at a slot level and symbol level. In one example, An SBFD configuration may be associated with one or multiple scheduling behaviors, e.g., for “dynamic grant”, for “configured grant”, for “any”. An SBFD configuration and/or parameters associated with an SBFD configuration may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE.

For example, an SBFD configuration and/or parameters associated with the SBFD configuration may be provided to the UE by means of common RRC signaling using SIB, or be provided by UE-dedicated RRC signaling such as ServingCellConfig. For example, an SBFD configuration and/or parameters associated with the SBFD configuration may be provided to the UE using an RRC-configured TDRA table, or a PDCCH, PDSCH, PUCCH or PUSCH configuration, and/or DCI-based signaling that can indicate to the UE a configuration or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding resource blocks (RBs) in an NR carrier BW that are not within a configured or an active UE BWP. An SBFD subband configuration may be provided based on a reference RB and/or based on a reference SCS. The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration for sbfd-config may be provided to the UE using tdd-UL-DL-ConfigurationCommon as example for RRC common configuration and/or tdd-UL-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE or by RRC signaling when the UE is configured with an SCell or additional SCGs by an IE ServingCellConfigCommon in RRC_CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types ‘D’, ‘U’ or ‘F’ using at least one time-domain pattern with configurable periodicity.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be gNB or UE panel specific or common across panels. In some examples, an UL TCI state may be replaced by an SRS resource indicator (SRI).

In certain embodiments, a cell may include or consist of more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

When considering UE procedures for discontinuous reception, UE procedures for receiving control information and UE procedures for enabling adaptation to monitoring of physical downlink control channels (PDCCHs) via PDCCH monitoring indication or indication of dormancy/non-dormancy for SCells in a full-duplex wireless communication system, several issues related to limitations and drawbacks of existing technology need to be overcome.

A first issue relates to different received SINR conditions, or different QCL assumptions, in non-SBFD slots/symbols and in SBFD slots/symbols, respectively, or in different SBFD subbands.

It needs to be considered that for transmissions by a gNB using one or more TRPs on a cell in a full-duplex system, a different number of transmitter/receiver antennas, a different effective transmitter antenna aperture area, and/or different transmitter antenna directivity settings may be available for transmissions in a DL slot or symbol, i.e., non-SBFD slot or symbol, when compared to transmissions in a SBFD slot or symbol. Similar considerations may apply to gNB or TRP receptions in a normal UL slot or symbol when compared to gNB or TRP receptions in the UL subband of a SBFD slot. For example, the EPRE settings for transmissions by a gNB using one or more TRPs on a cell in a SBFD slot or symbol with full-duplex operation may be constrained to prevent TRP-side receiver AGC blocking and to enable effective implementation of serial interference cancellation (SIC) during TRP receptions in the UL subband of the SBFD slot or symbol when comparted to the EPRE settings of TRP transmissions in the normal DL slot. Therefore, the TRP transmission power budget and, correspondingly, the received signal strength available for the UE receiver, may not be same for a signal/channel being transmitted by the TRP on a non-SBFD slot/symbol when compared to transmission by the TRP of a same signal/channel on an SBFD slot/symbol. Similar observations hold when full-duplex transmission and reception by a gNB on a cell based on multiple antenna panels from one or more TRPs is implemented. For example, QCL and transmit timing may vary between different panels of a TRP or among different TRPs. The transmissions or receptions on a cell from/by a TRP may be subjected to different link gains depending on the antenna panel used in a transmission or reception instance. Transmissions to or receptions from a same UE using different TRPs may be subjected to different link gains depending on the TRP for a transmission or reception instance. Similar observations hold for transmissions or receptions using different SBFD subbands where different link conditions may result with respect to a same UE scheduled from the gNB or across TRPs. For example, the available DL Tx power budget at a TRP for transmissions on a cell may be more restricted in an SBFD subband when compared to another SBFD subband of the TRP. For example, a TRX configuration or an SBFD antenna configuration or an EPRE limitation(s) arising from the frequency-domain placement of the SBFD subband in the NR carrier bandwidth to ensure sufficient adjacent channel protection may be different for different TRPs.

Furthermore, interference levels experienced by the UE receiver may differ between receptions in a normal DL slot or symbol and receptions in a SBFD slot or symbol. For example, the UE receiver during receptions in a normal DL slot may be interfered by co-channel transmissions from TRPs in neighboring cells. The UE receiver during receptions in an SBFD slot or symbol may be subjected to UE-to-UE inter-subband co-channel and/or UE-to-UE adjacent channel cross-link interference (CLI) stemming from UL-to-DL transmissions in the SBFD slot or symbol. Therefore, the resulting interference power levels and their variation experienced by the UE receiver may not be same for reception of a signal/channel on non-SBFD slot/symbol when compared to reception of the signal/channel on an SBFD slot/symbol. Similar observations hold for transmissions or receptions using different SBFD subbands where different interference levels may result with respect to a same UE scheduled from one or more TRPs of a cell. For example, adjacent channel interference may affect a first SBFD DL subband in the upper part of the NR channel bandwidth more than a second SBFD DL subband in the lower part of the NR channel bandwidth. For example, UE-to-UE inter-subband co-channel interference may not be symmetric with respect to the UE actual transmission bandwidth of the aggressor UE, i.e., it can depend on the active UL BWP, the PUSCH transmission bandwidth allocation, or the UE Tx filtering. In presence of intra-cell or inter-cell TRP operation, larger variations may be expected due to non-co-location of the TRPs.

Due to the different received SINR conditions in non-SBFD slots/symbols and in SBFD slots/symbols, or in the SBFD subbands of an SBFD slot/symbol, embodiments of the present disclosure recognize that it would be beneficial for a UE to be separately indicated to perform PDCCH monitoring in a DRX on-duration of a DRX cycle for non-SBFD slots/symbols and for SBFD slots/symbols upon reception of the Wake-up indication by the UE in a DCI format 2_6. For example, when the gNB determines that a received SINR at the UE is low in SBFD slots/symbols, for example based on a CSI report by the UE or based on a PDCCH link adaptation function in the gNB, the gNB can indicate to the UE to skip PDCCH monitoring in SBFD slots/symbols for a duration. The UE can be separately indicated whether or not to perform PDCCH monitoring for the DRX on-duration on non-SBFD slots/symbols. Note that in general, due to the different received SINR conditions and the different rate of variability in received SINR conditions at the UE in SBFD slots/symbols and non-SBFD slots/symbols, it is beneficial to enable separate adaptation of PDCCH monitoring in SBFD slots/symbols and in non-SBFD slots/symbols. Such separate adaptation can increase radio link robustness. Adaptation of PDCCH reception/monitoring in a DRX on-duration of a DRX cycle by a UE with respect to receptions in non-SBFD and/or SBFD slots/symbols can also enable the UE to reduce power consumption. Potential UE power-savings increase as a number of consecutive SBFD slots/symbols increases as the UE can then make use of a longer “sleep” duration in the UE modem implementation and shut-down UE receive components.

Embodiments of the present disclosure recognize that a second issue relates to the UE modem design complexity and increased UE power consumption for supporting PDCCH receptions in a non-contiguous receive bandwidth in the SBFD subbands.

Embodiments of the present disclosure consider that the PDCCH monitoring in a C-DRX on-duration or during active time by the UE in the SBFD DL subbands on SBFD slots/symbols, respectively, may require separate UE-side RF receiver processes for the SBFD DL subbands. When SBFD operation in FR1 or FR2-1 is supported by the gNB using a single NR carrier, receptions by the SBFD-aware UE of DL signals/channels on SBFD symbols in the first and the second SBFD DL subband, respectively, may need to be performed in the active UE DL BWP using two separate ADC and/or FFT processes, i.e., per-SBFD subband instead of per active DL BWP. This is different when compared to receptions of a DL signal/channel on a symbol by a legacy UE of the single NR carrier wherein the active DL BWP of the UE in the NR carrier has contiguous reception bandwidth. A legacy UE can use one ADC and/or FFT process for reception of the active DL BWP. Note that an example SBFD configuration for FR1 band n78 (3.5 GHz) uses a 100 MHz wide single NR carrier with a 20 MHz wide center SBFD UL subband. When in C-DRX, the active DL BWP of the SBFD-ware UE may need to be configured larger than for a legacy UE if the SBFD-aware UE is to receive a DL signal/channel, e.g., PDCCH, in the first and the second SBFD DL subbands. For example, an DL BWP of size 20 MHz may be configured for the legacy UE in C-DRX whereas a DL BWP of size 60 MHz may need to be configured for the SBFD-aware UE in C-DRX due to the presence of the SBFD UL subband. The UE power consumption for reception of a symbol in the DRX on-duration or during active time is then correspondingly increased for the SBFD-aware UE when compared to that of the legacy UE.

Due to the higher UE modem implementation requirements associated with SBFD subband reception such as in SBFD configurations of type ‘DUD’, it would be beneficial for a gNB to separately indicate to a UE to perform PDCCH monitoring in a DRX on-duration of a DRX cycle for an SBFD subband upon reception of the Wake-up indication by the UE in a DCI format 2_6. Adaptation of the PDCCH reception in a DRX on-duration of a DRX cycle by a UE with respect to receptions in an SBFD subband of an SBFD slot/symbol can enable the UE to reduce the UE power consumption. Potential UE power savings increase when the receptions of non-contiguous SBFD subbands can be avoided by the UE as the UE modem implementation can then make use of a single ADC/FFT process. Furthermore, UE modem design complexity may be reduced because the need to perform multiple separate channel estimation processes in a slot, i.e., per SBFD subband can be avoided.

Embodiments of the present disclosure recognize that a third issue relates to inter-operability constraints for supporting SBFD operation in a full-duplex (FD) system with transmissions to and/or receptions from a UE based on multiple TRPs.

Embodiments of the present disclosure considers that SBFD operation may not be deployed or supported by all gNBs or TRPs in an operator's TDD network. It can be expected that the availability and actual use of the SBFD feature during system operation in a deployment and the SBFD configuration in a cell may depend on a number of factors such as benefits, operational constraints and KPIs. Some gNBs or TRPs in the deployment grid may support SBFD but other gNBs or TRPs may not. For example, gNBs in one network segment from a first network vendor may support SBFD but gNBs in another network segment from a second network vendor may not. In another example, gNBs or TRPs on lower frequency layers of the operator's TDD network may not support SBFD operation while gNBs or TRPs of the same operator on higher frequency layers may support SBFD operation. Some but not all gNBs or TRPs of a same vendor in a network segment may implement and support SBFD operation but it may not be assumed that these gNBs or TRPs use a same SBFD configuration in time and/or frequency domains. For example, gNBs or TRPs deployed for urban macro layer coverage by the operator may support SBFD operation using ‘DUD’ but gNBs or TRPs of the same operator deployed for indoor coverage or industrial service may use a different SBFD configurations such as ‘DU’, or none at all. A different size and location of the frequency-domain allocation for the SBFD UL subband may be configured for different gNBs or TRPs due to different available NR carrier bandwidths on the NR channels. gNBs on different frequency layers, i.e., on different NR bands, of a same operator may not operate synchronously with respect to SFN. While gNB phase synchronization and alignment of gNB transmission timing is required for TDD operation on a same NR channel and in a same NR band, gNB timing alignment for dual-connectivity including EN-DC or NR-NR DC is not always possible to achieve due to practical site and deployment constraints. TRPs deployed for intra-cell or inter-cell operation by the operator may not always allow for both DL transmissions and UL receptions to/from a UE, e.g., a TRP may be used for DL-only transmissions to a UE or for UL-only receptions from a UE. The SBFD feature may or may not be available on a TRP due to antenna dimensioning, antenna integration and civil engineering constraints. Some TRPs may need to configure and use a separate SBFD configuration when compared to another TRP on a same cell. For example, when the SBFD feature is available on a first and on a second TRP in a cell or across cells, SBFD operation may be used on the first TRP but not on the second TRP due to a high resource utilization ratio or a high cross-link interference (CLI) level observed with respect to the SBFD operation on the second TRP until network conditions or network KPIs change.

Therefore, for UE operation when configured with C-DRX in RRC_CONNECTED mode across the TRP A with and TRP B without SBFD support, or across the TRP A and TRP B both with SBFD support on a frequency layer, embodiments of the present disclosure recognize that it is beneficial to support different SBFD configurations to the UE for ease of deployment and inter-operability. Embodiments of the present disclosure recognize that there is a need to provide solutions and procedures to separately control or adjust PDCCH receptions associated with reception of a Wake-up indication by the UE for the DRX on-duration of a DRX cycle in a full-duplex system with respect to separately or jointly configured and/or indicated SBFD configurations of TRP A and/or TRP B. Adaptation of PDCCH reception/monitoring associated with reception of a Wake-up indication in a DRX on-duration of a DRX cycle by a UE with respect to receptions in non-SBFD and/or SBFD slots/symbols of a TRP A and/or a TRP B can enable the UE to reduce power consumption. Potential UE power-savings increase as a number of CORESETS to be simultaneously received by the UE decreases and a as a number of consecutive slots/symbols without need for PDCCH reception increases. The UE can then make use of a longer “sleep” duration in the UE modem implementation and shut-down UE receive components.

Therefore, embodiments of the present disclosure recognize that there is a need to provide procedures for supporting separate indication for PDCCH reception in a DRX on-duration or during DRX active time following reception of a Wake-up indication in a DCI format 2_6 for non-SBFD slots/symbols, for SBFD slots/symbols, or for an SBFD subband, and/or with respect to PDCCH receptions from a TRP A and/or TRP B.

Embodiments of the present disclosure recognize that with reference to Rel-17 NR specifications, when a UE is configured with higher layer parameter ps-RNTI and dci-Format2-6, one block is configured for the UE by higher layers with the following fields: Wake-up indication of size L=1 bit and SCell dormancy indication of size M=1 . . . 5 bits (if the higher layer parameter dormancyGroupOutsideActiveTime is configured and M=0 bits otherwise). The size of the DCI format 2_6 is indicated to the UE by higher layer parameter sizeDCI-2-6. The starting position of the block in the DCI format 2_6 is determined by the UE based on the higher layer parameter ps-PositionDCI-2-6.

In one embodiment, a UE is provided by higher layers from a serving gNB a new parameter, for example DCP-Config-rxx, for reception of a Wake-up indication that selectively enables or disables PDCCH reception in a DRX on-period associated with a DRX cycle on a slot or symbol type or based on an SBFD subband type. For example, a slot or symbol type may correspond to ‘SBFD’ or ‘non-SBFD’, or may correspond to ‘D’ or ‘F’ or ‘U’. For example, an SBFD subband type may correspond to an SBFD DL subband, an SBFD UL subband, or an SBFD flexible subband. For example, DCP-Config-rxx can include a set or a combination of symbol or slot types such as ‘D and F’ or a set or a combination of SBFD subband types such as ‘SBFD DL and flexible subband’ with respect to PDCCH receptions from the gNB or a TRP.

A motivation to enable selective indication of a slot or symbol type for PDCCH reception in a DRX on-duration based on reception of a Wake-up indication by the UE for a first (initial) period of the associated DRX on-duration is increased UE power savings during the first period. For example, a subsequent PDCCH monitoring adaptation for PDCCH reception on non-SBFD and/or SBFD slots/symbols in a (later) second period of the associated DRX on-duration or during DRX active time may then be indicated by the gNB, e.g., using PDCCH skipping or SSSG switching functionality. A motivation to enable selective indication of an SBFD subband for PDCCH reception in a DRX on-duration is increased UE power savings. For example, for the UE active DL BWP, a single ADC and/or FFT process can then be used for PDCCH receptions in an SBFD subband instead of separate multiple ADC and/or FFT processes which would be required if the UE needs to receive in multiple SBFD subbands in the active DL BWP. Upon reception of the Wake-up indication in a first receive bandwidth in the active DL BWP, e.g., on the CORESET configured for reception of the DCI format 2_6, the UE can re-configure and adjust its receiver components for subsequent PDCCH receptions prior to the first symbol of the associated DRX on-duration in a second receive bandwidth wherein the second receive bandwidth may use a single ADC and/or FFT. It needs to be considered that the minimum time gap between possible reception of the Wake-up indication prior to PDCCH receptions in the associated DRX on-duration can allow for UE receiver re-configuration and modem adjustment without interruption to DL transmissions whereas a UE receiver re-configuration with respect to the reception bandwidth occurring in the DRX on-period or during DRX active time may result in an interruption.

In one example, the Wake-up indication can enable or disable PDCCH reception by the UE in the DRX on-period associated with the next long DRX cycle on the SBFD symbols/slots, or on the non-SBFD symbols/slots, or on both the SBFD and non-SBFD symbols/slots. In another example, the Wake-up indication can enable or disable PDCCH reception for the UE in the DRX on-period associated with the next long DRX cycle on a selected SBFD subband.

In one embodiment, the DCI format 2_6 in Rel-17 NR specifications is re-used. The Wake-up indication field is L=1 bit and the SCell dormancy indication field, if configured, is up to M=5 bits in a block configured for the UE by higher layers. The PDCCH reception for the UE in the DRX on-period is configured for the UE based on a new higher layer parameter. For example, PDCCH reception using SBFD symbols/slot only, or using non-SBFD symbols/slots only, or using both SBFD and non-SBFD symbols/slots, or using a selected SBFD subband is configured by a new higher layer parameter DCP-Config-rxx. The UE determines the size of the DCI format 2_6 by higher layer parameter sizeDCI-2-6. The UE determines the starting position of the block in the DCI format 2_6 based the parameter ps-PositionDCI-2-6. The UE determines a PDCCH reception behavior associated with a DRX on-duration of a DRX cycle for a value of the Wake-up indication bit based on the DCP-Config-rxx. A motivation for re-using DCI format 2_6 is reduced specification impact and reduced UE implementation effort. Selective indication of PDCCH monitoring in a DRX on-duration associated with the Wake-up indication can be supported by existing L1 functionality.

For example, the PDCCH reception behavior provided to the UE by DCP-Config-rxx may correspond to ‘stay asleep’, e.g., a ‘0’ value of the Wake-up indication indicates to not start the drx-onDurationTimer for the next long DRX cycle. A ‘1’ value may indicate ‘PDCCH reception on non-SBFD symbols only’, e.g., the UE starts the drx-onDurationTimer for the next long DRX cycle and attempts to receive a PDCCH only on non-SBFD symbols/slots of the DRX on-duration. Or, one or a combination of UE reception behaviors associated with a ‘1’ value of the Wake-up indication may be configured for the UE by DCP-Config-rxx such that ‘PDCCH reception on SBFD symbols’ only, ‘PDCCH reception on non-SBFD and SBFD symbols’, or ‘PDCCH reception in SBFD DL subband 1 only’, ‘PDCCH reception in SBFD DL subband 2 only’, or ‘PDCCH reception in both SBFD DL subband 1 and 2’, etc., is indicated. It can be seen that the designation of ‘0’ or ‘1’ values is chosen for illustration purposes only.

In one embodiment, a new interpretation of fields in DCI format 2_6 is used. The Wake-up indication field is L bits, e.g., L=2, and the SCell dormancy indication field, if configured, is up to M bits in a block as configured for the UE by higher layers. In one variant of the example, the maximum block size Bₘₐₓ of the block configured for the UE by higher layers, e.g., based on the L Wake-up indication bits and the M bits SCell Dormancy Indication bitmap, if present, is the same as in DCI format 2_6, e.g., L+M=Bₘₐₓ=6. For L=2, a size restriction of at most M=4 bits for the SCell Dormancy Indication bitmap for the UE can be imposed. In another variant of the example, the maximum block size Bₘₐₓ of the block configured for the UE by higher layers, e.g., based on the L Wake-up indication bits and the M bits SCell Dormancy Indication bitmap, if present, is different from DCI format 2_6. For example, L+M=Bₘₐₓ=7 and for L=2, M=5 bits for the SCell Dormancy Indication bitmap are possible. A same number of SCell group(s) configured by higher layer parameter dormancyGroupOutsideActiveTime as in a block of DCI format 2_6 can then be supported for the UE. The block configured for a legacy UE and the block configured for the later release UEs supporting SBFD operation can still be multiplexed into a same DCI format 2_6 even when the blocks have different lengths. This is because the legacy UE and the later release UE are separately provided with a configuration of the starting position of a block in the DCI format 26 by the gNB. The UE determines the size of the DCI format 2_6 by higher layer parameter sizeDCI-2-6. The UE determines the starting position of the block in the DCI format 2_6 based the parameter ps-PositionDCI-2-6. The UE determines a value, e.g., codepoint, for the Wake-up indication bit or bits based on the starting position and the number of L bits configured. A motivation is improved PDCC monitoring adaptability while preserving the ability to multiplex legacy and new release UEs based on a same DCI format 26 signaling design.

For example, PDCCH reception for the UE in the DRX on-period associated with the DRX cycle using only the SBFD symbols/slots, or using only the non-SBFD symbols/slots, or using both the SBFD and non-SBFD symbols/slots, or using a selected SBFD subband, is configured for the UE based on a new higher layer parameter DCP-Config-rxx. For L>1 bit, the Wake-up indication field can indicate separate PDCCH reception behaviors to the UE in the DRX on-period. For example, when L=2, a Wake-up indication using codepoint ‘00’ may indicate ‘stay asleep’, a codepoint ‘01’ may indicate ‘PDCCH reception on non-SBFD symbols only’, a codepoint ‘10’ may indicate ‘PDCCH reception on SBFD symbols only’ and a codepoint ‘11’ may indicate ‘PDCCH reception on both non-SBFD and SBFD symbols’. The UE determines a PDCCH reception behavior associated with a DRX on-duration of a DRX cycle for a value of the Wake-up indication bit based on the DCP-Config-rxx. For example, the PDCCH reception behavior provided to the UE by DCP-Config-rxx for a ‘00’ value of the Wake-up indication may correspond to not start the drx-onDurationTimer for the next long DRX cycle. A ‘01’ value may correspond to ‘PDCCH reception on non-SBFD symbols only’, e.g., the UE starts the drx-onDurationTimer for the next long DRX cycle and attempts to receive a PDCCH on non-SBFD symbol/slot of the DRX on-duration. A ‘10’ value may correspond to ‘PDCCH reception on SBFD symbols only’, e.g., the UE starts the drx-onDurationTimer for the next long DRX cycle and attempts to receive a PDCCH on SBFD symbol/slot of the DRX on-duration. A ‘11’ value may correspond to ‘PDCCH reception on both non-SBFD and SBFD symbols only’, e.g., the UE starts the drx-onDurationTimer for the next long DRX cycle and attempts to receive a PDCCH on the non-SBFD and the SBFD symbol/slot of the DRX on-duration.

In one embodiment, using the legacy field size L=1 bit or a new field size L>1 bit for the Wake-up indication, one of multiple possible or allowed PDCCH reception behaviors in the DRX on-period associated with the DRX cycle may be configured for the UE by a new higher layer parameter DCP-Config-rxx. For example, when L=2, a first possible or allowed configurable PDCCH reception behavior may correspond to codepoint ‘00” indicating ‘stay asleep’, a codepoint ‘01’ indicating ‘PDCCH reception on non-SBFD symbols only’, a codepoint ‘10’ indicating ‘PDCCH reception on SBFD symbols only’ and a codepoint ‘11’ indicating ‘PDCCH reception on both non-SBFD and SBFD symbols’. For example, when L=2, a second possible or allowed configurable PDCCH reception behavior may correspond to codepoint ‘00’ indicating ‘stay asleep’, a codepoint ‘01’ indicating ‘PDCCH reception on non-SBFD symbols only’, a codepoint ‘10’ indicating ‘PDCCH reception in SBFD DL subband 1 only’ and a codepoint ‘11’ indicating ‘PDCCH reception in SBFD DL subbands 1 and 2’. For example, when L=2, a third possible or allowed configurable PDCCH reception behavior may correspond to codepoint ‘00’ indicating ‘stay asleep’, a codepoint ‘01’ indicating ‘PDCCH reception on non-SBFD symbols based on PDCCH configuration 1’, a codepoint ‘10’ indicating ‘PDCCH reception on SBFD symbols based on PDCCH configuration 2’, and a codepoint ‘11’ indicating ‘PDCCH reception in both non-SBFD and SBFD symbols based on PDCCH configuration 1’. It can be seen that the designation of codepoints or values ‘00’, ‘01’, ‘10’ or ‘11’ for the case of L=2 Wake-up indication bits is chosen for illustration purposes only.

With respect to a higher layer provided UE reception behavior associated with a DRX on-duration of a DRX cycle or when in DRX-active time for a Wake-up indication of L bits, in one example, the UE is provided by higher layers a set of four PDCCH reception behaviors b1, b2, b3 and b4. PDCCH reception behavior b1 is associated with no PDCCH reception in the DRX on-duration. PDCCH reception behavior b2 is associated with PDCCH reception on non-SBFD symbols, but no PDCCH reception on SBFD symbols. PDCCH reception behavior b3 is associated with PDCCH reception on SBFD symbols, but no PDCCH reception on non-SBFD symbols. PDCCH reception behavior b4 is associated with PDCCH reception on both SBFD and non-SBFD symbols. The UE can be provided with a set of indication values associated with the set of higher-layer PDCCH reception behaviors b1, b2, b3 and b4, e.g., using codepoints ‘00’, ‘01’, ‘01’ and ‘11’ for an indication of PDCCH reception behaviors b1, b2, b3 and b4, respectively. For example, an L=2, or two-bit field of a DCI format 2_6 can be used to signal an indication of a higher layer PDCCH reception behavior in a DRX on-duration or during DRX active time to the UE.

When the UE is indicated to use PDCCH reception behavior b2, the UE monitors PDCCH receptions on the non-SBFD symbols but not on the SBFD symbols according to parameters such as monitoringSlotPeriodicityAndOffset provided by higher-layer PDCCH configuration. When the UE is indicated to use PDCCH reception behavior b3, the UE skips PDCCH receptions on the non-SBFD symbols but not on the SBFD symbols, and the UE monitors PDCCH reception according to parameters such as monitoringSlotPeriodicityAndOffset provided by higher-layer PDCCH configuration. When the UE is indicated to use PDCCH reception behavior b4, the UE monitors PDCCH reception on both SBFD and non-SBFD symbols according to parameters such as monitoringSlotPeriodicityAndOffset provided by higher-layer PDCCH configuration.

For example, a higher layer provided PDCCH reception behavior may be associated with a duration. A same value of a duration or different values of durations may be associated with the PDCCH reception behaviors. For example, PDCCH reception behavior b2 associated with PDCCH reception on non-SBFD symbols may be configured by higher layers for a duration of d2=80 msec, but PDCCH reception behavior b3 associated with PDCCH reception on SBFD symbols may be configured by higher layers for a duration of d3=40 msec. A higher-layer provided duration may correspond to a default value which is assumed by the UE if no value is provided by higher layers. A motivation is to configure a PDCCH reception behavior for a first (initial) period of PDCCH reception in a DRX on-duration before the UE can fallback or adjust to another PDCCH reception behavior in a second (later) period of PDCCH reception in the DRX on-duration.

In another example, the UE is provided by higher layer a set of four PDCCH reception behaviors b1, b2, b3 and b4. PDCCH reception behavior b1 is associated with no PDCCH reception in the DRX on-duration of a DRX cycle. PDCCH reception behavior b2 is associated with PDCCH reception in a DRX on-duration on SBFD DL subband 1 only, but no PDCCH reception on another SBFD subband such as SBFD DL subband 2 or an SBFD flexible or UL subband. PDCCH reception behavior b3 is associated with PDCCH reception in a DRX on-duration on SBFD DL subband 2 only, but no PDCCH reception on another SBFD subband such as SBFD DL subband 1 or an SBFD flexible or UL subband. PDCCH reception behavior b4 is associated with PDCCH reception on SBFD DL subband 1 and 2. For example, a CORESET in the NR carrier BW may be configured for the UE such that RBs of the CORESET are comprised within the SBFD DL subbands 1 and 2. In another example, two CORESETs, wherein a CORESET is contained within an SBFD DL subband may be configured for the UE.

When the UE is indicated to use PDCCH reception behavior b2, the UE monitors PDCCH receptions on the SBFD DL subband 1, but not on the SBFD DL subband 2 according to parameters such as monitoringSlotPeriodicityAndOffset provided by higher-layer PDCCH configuration. When the UE is indicated to use PDCCH reception behavior b3, the UE monitors PDCCH receptions on the SBFD DL subband 2 but not on SBFD DL subband 1 according to parameters such as monitoringSlotPeriodicityAndOffset provided by higher-layer PDCCH configuration. When the UE is indicated to use PDCCH reception behavior b4, the UE monitors PDCCH receptions on the SBFD DL subband 1 and 2 according to parameters such as monitoringSlotPeriodicityAndOffset provided by higher-layer PDCCH configuration.

For example, a higher layer provided PDCCH reception behavior may be associated with a duration. A same value of a duration or different values of durations may be associated with the PDCCH reception behaviors. For example, PDCCH reception behavior b2 associated with PDCCH reception on SBFD DL subband 1 may be configured by higher layers for a duration of d2=120 msec, but PDCCH reception behavior b3 associated with PDCCH reception on SBFD DL subband 2 may be configured by higher layers for a duration of d3=320 msec. A motivation is to enable selective indication of an SBFD subband by the gNB for PDCCH reception in a DRX on-duration upon reception of a Wake-up indication by the UE for a first (initial) period of the DRX on-duration to reduce the UE receive bandwidth which may be followed by another desired adjustment of PDCCH reception by the gNB in a second (later) period of the DRX on-duration or during DRX active time, e.g., using BWP adaptation, if reception bandwidth to support higher served traffic needs to be increased. A higher-layer provided duration may correspond to a default value which is assumed by the UE if no value is provided by higher layers.

A motivation for enabling different PDCCH reception behaviors for the UE in the Wake-up indication associated with a DRX on-duration of a DRX cycle or when in DRX active time, including different durations, for PDCCH reception in non-SBFD symbols or slots and in SBFD symbols or slots is increased link robustness when operating on a serving cell supporting full-duplex operation. By selectively enabling or disabling PDCCH monitoring in the DRX on-duration based on a slot/symbol type, or based on an SBFD subband type, using DCP-Config-rxx, a gNB can adjust the PDCCH monitoring based on DCI indication for a UE to a subset of time-domain or frequency-domain resources corresponding to the SBFD configurations associated with a gNB or for TRP A and/or TRP B, respectively.

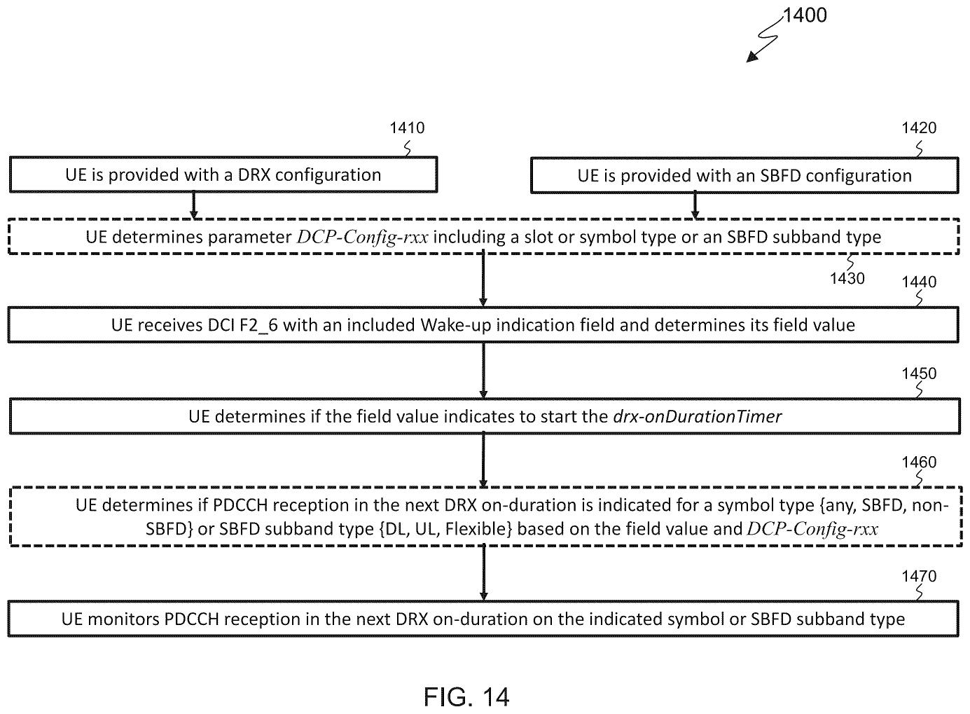

FIG. 14 illustrates an example flowchart for a process 1400 of a wake-up indication associated with PDCCH reception in a DRX on-period for a slot or symbol type or for an SBFD subband type in a full-duplex communication system according to embodiments of the present disclosure. For example, the process 1400 may be performed by a UE such as UE 116 in FIG. 3 and a corresponding process may be performed by a base station such as gNB 102 in FIG. 2. The illustration of the process 1400 is for example and is not a limitation on the embodiments of the present disclosure.

The process 1400 begins with the UE being provided with a DRX configuration, 1410. The UE is provided with an SBFD configuration, 1420. The UE determines a parameter DCP-Config-rxx providing an indicated slot or symbol type or an indicated SBFD subband type for PDCCH reception in an associated DRX on-duration, 1430. The UE receives a DCI format 2_6 that provides a Wake-up indication field and determines a field value, 1440. The UE determines if the field value indicates to start PDCCH reception in the associated DRX on-duration, e.g., if the drx-onDurationTimer is to be started, 1450. If the UE determines that start of PDCCH reception is indicated by the field value, the UE further determines if a PDCCH reception in the associated DRX on-duration is indicated for one or a combination of symbol type {SBFD, non-SBFD} and for one or a combination of SBFD subband, 1460. The UE then monitors for PDCCH receptions on an indicated symbol type or an indicated SBFD subband type in the DRX on-duration of a DRX cycle associated with the reception of the Wake-up indication, 1470.

Considering the existence of SBFD and non-SBFD resources and of multi-TRP operation, e.g., for a first TRP and for a second TRP, a Wake-up indication field of size L-2, L=4 bits or L=6 bits, can provide additional flexibility. A motivation is that the larger a number of L bits for the Wake-up indication field, the larger the number of PDCCH reception behaviors that can be indicated per TRP and per resource type (SBFD or non-SBFD).

In one embodiment, a Wake-up indication associated with a DRX on-duration of a DRX cycle may be configured by higher layers for the UE with respect to possible or allowed PDCCH reception behaviors for one or a combination of TRPs.

For example, a mapping of values to PDCCH reception behaviors for the Wake-up indication field for combinations of {SBFD, non-SBFD}resources and of {TRP A, TRP B}can be defined where the combinations can be indicated by higher layers. For example, a first combination can be no PDCCH reception on any TRP, a second combination can be {non-SBFD, TRP A, TRP B} a third combination can be {SBFD, TRP A, TRP B}, a fourth combination can be {SBFD, non-SBFD, TRP A}, a fifth combination can be {SBFD, non-SBFD, TRP A, TRP B}, and so on. A same combination can be mapped to multiple values of the Wake-up indication field associated with different PDCCH reception behaviors associated with the DRX on-duration with respect to a TRP for the combination. It is also possible that a DCI format 2_6 includes two fields or two blocks for the UE; a first field or block indicating a PDCCH reception behavior on SBFD resources for both TRP A and TRP B, and a second indicating a PDCCH reception behavior on non-SBFD resources for both TRP A and TRP B. It is also possible that a DCI format 2_6 or a transmission format based on it includes four fields or blocks for the UE; a first indicating a PDCCH reception behavior on SBFD resources for TRP A, a second indicating a PDCCH reception behavior on non-SBFD resources for TRP A, a third indicating a PDCCH reception behavior on SBFD resources for TRP B, and a fourth indicating a PDCCH reception behavior on non-SBFD resources for TRP B.

In one embodiment, the UE determines an SBFD configuration for PDCCH receptions in a DRX on-period of a DRX cycle from the TRP based on a value in the Wake-up indication field, wherein the value is associated with an SBFD configuration.

In one example, the UE is provided with a Wake-up indication field of size L=2 bits. The UE is provided by RRC signaling such as RRCReconfiguration with a first SBFD configuration of type ‘DUD’ wherein an SBFD UL subband is configured on 51 center RBs in the NR carrier BW of an SBFD symbol and with a second SBFD configuration of type ‘none’, e.g., no SBFD configuration is provided (or an SBFD configuration is not indicated). The first and the second SBFD configurations are associated with a first subset K1 and a second subset K2 of the 2^{L} possible codepoints of the Wake-up indication, respectively. For example, the first SBFD configuration may be associated with codepoints ‘01’ and ‘10’ and the second SBFD configuration may be associated with codepoint ‘11’. The network can then indicate an SBFD configuration to be assumed or to be used by the UE for the PDCCH receptions in the associated DRX on-period based on a codepoint of the Wake-up indication field. In another example, when a codepoint of the Wake-up indication field is associated with an SBFD configuration, one codepoint may be associated with an SBFD configuration of a TRP A and one codepoint may be associated with an SBFD configuration of TRP B, respectively, to be assumed or to be used by the UE for the PDCCH receptions in the associated DRX on-period upon reception of the Wake-up indication.

When the UE receives a Wake-up indication that maps or associates a codepoint to an SBFD configuration and/or TRP, and the UE determines that a change from a current SBFD configuration and/or TRP reception is indicated by the DCI with the Wake-up indication, the UE further determines the SBFD configuration associated with the codepoint. For example, if a new SBFD configuration from the first subset K1 of an SBFD configuration is indicated by a codepoint of the Wake-up indication, the UE selects the first (example) SBFD configuration of type ‘DUD’ to adjust its receiver processing for PDCCH reception in the associated DRX on-period. For example, if an SBFD configuration from the second subset K2 is indicated, the UE selects the second SBFD configuration of type ‘none’ to adjust its receiver processing for the associated DRX on-period. The UE can then process PDCCH receptions based on or according to the first or the second SBFD configuration. For example, if the indicated SBFD configuration is from the first subset K1, the UE may not consider valid a CORESET allocation if the CORESET frequency-domain allocation comprises RBs in an SBFD UL subband of the first SBFD configuration, or the UE may configure its reception filtering setting based on the known frequency-domain location of the SBFD DL subbands based on the first SBFD configuration. For example, if the indicated SBFD configuration is from the second subset, the UE may consider valid any CORESET allocation in the active DL BWP, or the UE may configure its reception filtering setting based on the active UE DL BWP. A suitable activation delay and/or a validity duration for an SBFD configuration associated with a codepoint of a Wake-up indication may be used. A motivation is improved support and dynamicity of SBFD operation, e.g., SBFD-aware UEs configured with C-DRX in RRC_CONNECTED mode can then be indicated a change or adjustment of the SBFD configuration on the serving cell without sacrificing their power-saving performance. A motivation is to support higher flexibility to use different or separate SBFD configurations with multi-TRP reception.

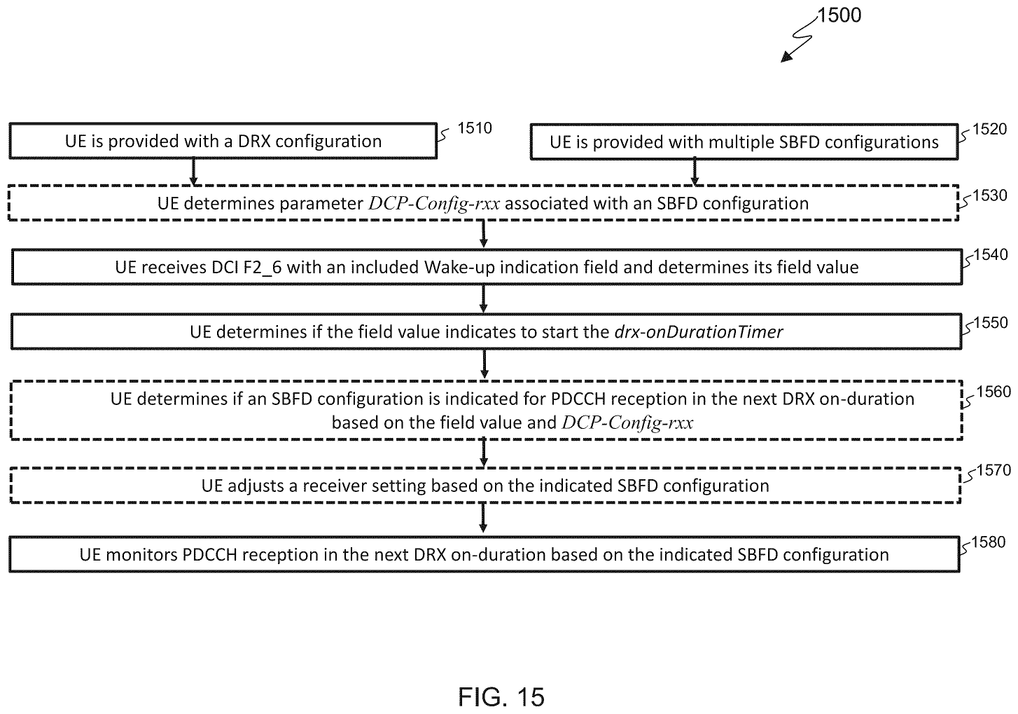

FIG. 15 illustrates an example flowchart for a process of a wake-up indication associated with PDCCH reception in a DRX on-period for an SBFD configuration in a full-duplex communication system according to embodiments of the present disclosure. For example, the process 1500 may be performed by a UE such as UE 116 in FIG. 3 and a corresponding process may be performed by a base station such as gNB 102 in FIG. 2. The illustration of the process 1500 is for example and is not a limitation on the embodiments of the present disclosure.

The process 1500 begins with the UE being provided with a DRX configuration, 1510. The UE is provided with multiple SBFD configurations, 1520. The UE determines a parameter DCP-Config-rxx associated with an SBFD configuration for an DRX on-duration of a DRX cycle, 1530. The UE receives a DCI format 2_6 that provides a Wake-up indication field and determines a field value, 1540. The UE determines if the field value indicates to start PDCCH reception in the associated DRX on-duration, e.g., if the drx-onDurationTimer is to be started, 1550. If the UE determines that start of PDCCH reception is indicated by the field value, the UE further determines if a PDCCH reception in the associated DRX on-duration is indicated with an associated SBFD configuration, 1560. If an SBFD configuration is indicated, the UE may adjust a UE receiver setting based on the indicated SBFD configuration, 1570. The UE then monitors for PDCCH receptions in the DRX on-duration of a DRX cycle associated with the reception of the Wake-up indication based on the indicated SBFD configuration, 1580.

In one embodiment, a UE is provided by higher layers from a serving gNB a new parameter DCP-Config-rxx for a Wake-up indication associated with a DRX on-duration of a DRX cycle or with a DRX active time that selectively enables or disables PDCCH reception with respect to a first symbol type such as ‘SBFD’ or ‘F’, but is not applicable to a second symbol type such as ‘non-SBFD’ or ‘D’ symbol.

For example, the new parameter DCP-Config-rxx then includes a set of PDCCH reception behaviors that is applicable only to the first symbol type, e.g., ‘SBFD’ or ‘F’ for a value of the Wake-up indication field. For the second symbols type, e.g., non-SBFD slots or ‘D’, a legacy DCP-Config-r16 parameter may be used to provide a configuration associated with a value of the Wake-up indication field. Similar principles extend to the case where the new parameter DCP-Config-rxx configures PDCCH reception behavior with respect to an SBFD subband. The new parameter DCP-Config-rxx may be used to provide a set of PDCCH reception behaviors for both non-SBFD time or frequency resources and for SBFD time or frequency resources. The new parameter DCP-Config-rxx may provide a configuration associated with one or with multiple values of a Wake-up indication field.

For example, when an extended Wake-up indication field of size L=3 bits is configured for a UE in a DCI format 2_6 associated with a DRX on-duration in a DRX cycle for PDCCH monitoring on a serving cell, and the set of (legacy) PDCCH monitoring behaviors provided to the UE by DCP-Config-r16 includes one value and the set of (new) PDCCH monitoring behaviors provided to the UE by DCP-Config-rxx includes three values, a value ‘0’ for the first (legacy) bit of the L=3 bits of the Wake-up indication field may indicate no PDCCH reception and a value ‘1’ may indicate PDCCH reception in the associated DRX on-duration. The last two (new) bits of the L=3 bits of the field may indicate (new) PDCCH reception behavior with respect to non-SBFD or SBFD symbols or an SBFD subband in the associated DRX on-duration. For example, values ‘00’/‘01’/‘10’/‘11’ respectively, may then indicate PDCCH reception in the associated DRX on-duration according a first/second/third/fourth PDCCH reception behavior from DCP-Config-rxx in SBFD symbols/slots or on an SBFD subband on the active DL BWP of the serving cell or with respect to a TRP. Similar procedures can apply if instead of bits from an extended Wake-up indication field, a new/additional Wake-up indication field is used to indicate a PDCCH reception behavior in an associated DRX on-duration from DCP-Config-rxx for non-SBFD or for SBFD symbols/slots or for an SBFD subband with respect to receptions from a gNB or from a TRP A or from TRP B, or from TRP A and TRP B.

In the following, parameter DCP-Config-rxx can provide a first set of PDCCH reception behaviors for non-SBFD symbols/slot and a second set of PDCCH reception behaviors for SBFD symbols/slots or for an SBFD subband, or can provide only a set of PDCCH reception behaviors for SBFD symbols/slots or for an SBFD subband while a legacy parameter DCP-Config-rxx can provide a (legacy) PDCCH reception behavior in the associated DRX on-duration of a DRX cycle.

A Wake-up indication field in a DCI can be any of:
a legacy Wake-up indication field, e.g., L=1, with a value that maps to more than one sets of values for respective more than one sets of PDCCH reception behaviors in a DRX on-duration, possibly including receptions from a TRP A or from TRP B, or from TRP A and TRP B, where the more than one sets of PDCCH reception behaviors are associated with non-SBFD slots and SBFD slots, or with an SBFD DL subband or an SBFD UL subband, or an SBFD flexible subband. The value may be applicable to both non-SBFD slots/symbols and SBFD slots/symbols, or may be applicable only to slots/symbols of same type as the slot/symbols of the PDCCH reception with the DCI. One of TRP A or TRP B may be a reference or a default TRP associated with PDCCH receptions on a serving cell.
an extended Wake-up indication field, e.g., L=2 or L=3, possibly with a number of bits that is larger than in case of non-full-duplex operation, where first bits from the number of bits provide a first value that maps to a first PDCCH reception behavior in a DRX on-duration in non-SBFD slots and second bits from the number of bits provide a second value that maps to a second PDCCH reception behavior in a DRX on-duration in SBFD slots, possibly with respect to receptions from TRP A or from TRP B, or from TRP A and TRP B. In similar manner, second bits from the number of bits may provide a second value that maps to a second PDCCH reception behavior in an SBFD DL subband, or an SBFD UL subband, or an SBFD flexible subband in a DRX on-duration, possibly with respect to receptions from TRP A or from TRP B, or from TRP A and TRP B. The first and second PDCCH reception behavior can be from a same set of or from separately provided sets of PDCCH reception behaviors. In that latter case, a number of first bits and a number of second bits can be different and be determined from a size of a corresponding set of PDCCH reception behaviors. One of TRP A or TRP B may be a reference or a default TRP associated with PDCCH receptions in a DRX on-duration following reception of a Wake-up indication on a serving cell.
a new Wake-up indication field, e.g., L=2, that is applicable to SBFD slots or symbols, or to PDCCH receptions in a configured or indicated SBFD DL subband, SBFD UL subband, or SBFD flexible subband, associated with a DRX on-duration of a DRX cycle, possibly with respect to receptions from TRP A or from TRP B, or from both TRP A and TRP B, while a legacy Wake-up indication field, or another new Wake-up indication field, is applicable to non-SBFD slots or symbols, or to PDCCH receptions in an SBFD DL subband, or an SBFD UL subband, or an SBFD flexible subband, possibly with respect to a reference or default TRP associated with PDCCH receptions on a serving cell. A first number of bits for the legacy Wake-up indication field, or for a first new Wake-up indication field, can be different from a second number of bits for the new Wake-up indication field, or for the second new Wake-up indication field, where the first and second numbers of bits can be determined from the sizes of corresponding sets of PDCCH reception behaviors. One of TRP A or TRP B may be a reference or a default TRP associated with PDCCH receptions in a DRX on-duration of a DRX cycle on a serving cell.

An indication value associated with a Wake-up indication and/or configured by higher layer parameter DCP-Config-rxx for PDCCH receptions may alternatively be provided to the UE using a unicast DCI such as DCI format 0_1/0_2/0_3/1_1/1_2/1_3 in [2]. The functionality of a Wake-up indication field for PDCCH monitoring in a DRX on-duration for receptions on SBFD or non-SBFD symbols or on SBFD subbands, with respect to TRP A and/or to TRP B, can also be applicable for a multicast DCI format, for a PDCCH associated with multicast DCI formats, such as DCI format 4_0/4_1 in [2]. A DCI format associated with a Wake-up indication and/or configured by higher layer parameter DCP-Config-rxx for PDCCH receptions may alternatively be provided to the UE using a separate RNTI value, e.g., ps-RNTI-rxx. For example, a Wake-up indication received by the UE in a DCI format 2_6 using a first ps-RNTI value may be associated with a first set of PDCCH reception behaviors in a DRX on-duration of a DRX cycle and a second ps-RNTI value may be associated with a second set of PDCCH reception behaviors in the DRX on-duration of the DRX cycle. For example, the first ps-RNTI value may indicate legacy UE behavior with respect to a configuration provided by higher layer parameter DCP-Config-rxx and the second ps-RNTI value may indicate UE behavior according to the PDCCH reception behaviors configured by DCP-Config-rxx.

For example, when a UE is provided by higher layers from a serving gNB a new parameter, for example DCP-Config-rxx, that configures a PDCCH reception behavior associated with a DRX on-duration or in DRX active time for a Wake-up indication, a codepoint in a Wake-up indication field of size L, e.g., L=4 bits, can indicate one or more of:
The symbol (or slot) types associated with a PDCCH reception in a DRX on-duration of a DRX cycle, e.g., SBFD and/or non-SBFD symbol/slots, or ‘D’ and/or ‘F’ and/or ‘U’ symbols/slots
The TRP or TRPs to monitor PDCCH, e.g., from TRP A and/or TRP B
The SBFD configuration associated with a DRX on-duration of a DRX cycle
The type of SBFD subband to monitor a PDCCH, e.g., SBFD DL subband, and/or SBFD UL subband, and/or first SBFD DL subband, and/or second SBFD DL subband, and/or SBFD flexible subband
The duration of PDCCH monitoring, wherein the duration can be in units of slots or symbols or sub-frames or frames, or milliseconds, etc.

In another example, a Wake-up indication to enable or disable PDCCH monitoring in a DRX on-duration of a DRX cycle or during DRX active time in a duration based on a slot or symbol type, or based on an SBFD subband type, may be provided to the UE by an association with a slot or symbol type, or by an association with an SBFD subband type, where the UE receives such a Wake-up indication. Therefore, an interpretation by the UE for an applicability of PDCCH monitoring can be for types of symbols or slots or types of SBFD subbands, such as non-SBFD or SBFD, that are same as a type of symbols or slots or subbands where the UE received a PDCCH that provides the DCI format with the Wake-up indication, and the indication is not applicable for PDCCH monitoring in symbols or slots or SBFD subbands of different types.

For example, parameter DCP-Config-rxx may be included in one or more RRC messages and/or IEs and a parameter DCP-Config-rxx may be received by the UE based on a system information block (SIB), such as a SIB1, or by a common RRC signaling, or by UE-specific RRC signaling. For example, and without loss of generality, DCP-Config-rxx may be provided by the gNB to the UE as part of RRC messages of type RRCSetup, RRCReconfiguration, SIB1 or SystemInformation, or may be included in RRC IEs of type ServingCellConfig, ServingCellConfigCommon, or ServingCellConfigSIB1. Such RRC configuration parameters may be of enumerated, listed or sequence type or may be encoded as a bit string. In one example, DCP-Config-rxx may be included in an IE of type PDCCH-Config. Multiple parameter sets for DCP-Config-rxx can be provided to the UE. Parameter DCP-Config-rxx may indicate slot/symbol indices or a set of slots/symbols where a UE monitors or does not monitor PDCCH receptions in a DRX on-duration associated with a Wake-up indication. The UE may be provided time-domain resources, e.g., slots/symbols, where the UE monitors or does not monitor PDCCH receptions in a DRX on-duration even when the UE determines that a slot/symbol or a slot/symbol type where a PDCCH reception may occur is part of a PDCCH configuration, e.g., associated with a PDCCH monitoring occasion. For example, DCP-Config-rxx may include a bitmap to indicate time-domain resources, such as based on an RRC parameter monitoringSlotsWithinSlotGroup or monitoringSymbolsWithinSlot, or frequency-domain resources based on an RRC parameter freqMonitorLocations for PDCCH monitoring associated with a DRX on-duration of a DRX cycle. DCP-Config-rxx may be associated with PDCCH configuration using a CCE aggregation level, such as for example limiting a UE when monitoring or not monitoring PDCCH receptions for an indicated CCE aggregation level, such as 8. DCP-Config-rxx may be associated with a resource type indication for monitoring or not monitoring PDCCH receptions, such as a slot or symbol or symbol group of a radio resource that may be of type ‘simultaneous Tx-Rx’, ‘Rx only’, or ‘Tx only’. For example, a resource type indication such as ‘simultaneous Tx-Rx’, ‘Rx only’, or ‘Tx only’ can be provided per slot type ‘D’, ‘U’ or ‘F’ in a slot or symbol. For example, a resource type may be associated with a configured or an indicated SBFD UL and/or DL subband. An indication of the resource type may be provided independently of the transmission direction of a slot or symbol indicated to the UE by the TDD UL-DL frame configuration provided by higher layers.

In one embodiment, a UE is provided by higher layers from a serving gNB a new parameter, for example ps-TransmitPeriodicL1-RSRP-rxx or ps-TransmitOtherPeriodicCSI-rxx that selectively enables or disables CSI reporting when the UE is configured with DRX for a slot or symbol type or based on an SBFD subband type.

For example, a slot or symbol type may correspond to ‘SBFD’ or ‘non-SBFD’, or may correspond to ‘D’ or ‘F’ or ‘U’. For example, an SBFD subband type may correspond to an SBFD DL subband, an SBFD UL subband, or an SBFD flexible subband. For example, ps-TransmitPeriodicL1-RSRP-rxx or ps-TransmitOtherPeriodicCSI-rxx can include a set or combination of symbol or slot types such as ‘D and F’ or a set or a combination of SBFD subband types such as ‘SBFD DL and flexible subband’ with respect to PDCCH receptions from the gNB or a TRP.

For example, when the UE is configured with DRX and the CSI reporting in power-save mode is enabled for the UE, the new parameter provided by higher layers from a serving gNB, e.g., ps-TransmitPeriodicL1-RSRP-rxx or ps-TransmitOtherPeriodicCSI-rxx, that configures CSI reporting behavior, can indicate one or more of the following:
The symbol (or slot) types associated with CSI reporting when in DRX, e.g., SBFD and/or non-SBFD symbol/slots, or ‘D’ and/or ‘F’ and/or ‘U’ symbols/slots
The TRP or TRPs for CSI reporting when in DRX, e.g., from TRP A and/or TRP B
The SBFD configuration associated with CSI reporting when in DRX,
The type of SBFD subband for CSI reporting, e.g., for SBFD DL subband and/or SBFD UL subband and/or first SBFD DL subband and/or second SBFD DL subband and/or SBFD flexible subband

For example, when DRX is configured, the UE provides a CSI report to the gNB only if receiving at least one CSI-RS transmission occasion for channel measurement and CSI-RS and/or CSI-IM occasion for interference measurement in DRX Active Time no later than CSI reference resource on the indicated SBFD and/or non-SBFD symbol or slot type or the SBFD subband type and drops the report otherwise. When DRX is configured and the CSI-RS Resource Set for channel measurement corresponding to a CSI report is configured with two Resource Groups and N Resource Pairs, the UE provides a CSI report only when the UE receives at least one CSI-RS transmission occasion for each CSI-RS resource in a Resource Pair within a same DRX Active Time no later than CSI reference resource on the indicated SBFD and/or non-SBFD symbol or slot type or the SBFD subband type and the UE drops the report otherwise. When the UE is configured to monitor PDCCH for DCI format 2_6 and if the UE configured by higher layer parameter ps-TransmitOtherPeriodicCSI to report CSI with the higher layer parameter reportConfigType set to ‘periodic’ and reportQuantity set to quantities other than ‘cri-RSRP’, ‘ssb-Index-RSRP’, ‘cri-RSRP-Index’, and ‘ssb-Index-RSRP-Index’ when drx-onDurationTimer is not started, the UE reports CSI during the time duration indicated by drx-onDurationTimer in DRX-Config also outside active time when the UE receives at least one CSI-RS transmission occasion for channel measurement and CSI-RS and/or CSI-IM occasion for interference measurement on the indicated SBFD and/or non-SBFD symbol or slot type or the SBFD subband type during the time duration indicated by drx-onDurationTimer in DRX-Config outside DRX active time, or in DRX Active Time, no later than CSI reference resource and drops the report otherwise. When the UE is configured to monitor PDCCH for DCI format 2_6 and if the UE is configured by higher layer parameter ps-TransmitPeriodicL1-RSRP to report L1-RSRP with the higher layer parameter reportConfigType set to ‘periodic’ and reportQuantity set to ‘cri-RSRP’, ‘ssb-Index-RSRP’, ‘cri-RSRP-Index’, or ‘ssb-Index-RSRP-Index’ when drx-onDurationTimer is not started, the UE reports L1-RSRP on the indicated SBFD and/or non-SBFD symbol or slot type or SBFD subband type during the time duration indicated by drx-onDurationTimer in DRX-Config also outside active time, and when reportQuantity is set to ‘cri-RSRP’ or ‘cri-RSRP-Capability [Set] Index’, when the UE receives at least one CSI-RS transmission occasion for channel measurement on the indicated SBFD and/or non-SBFD slot or symbol type or SBFD subband type during the time duration indicated by drx-onDurationTimer in DRX-Config outside DRX active time, or in DRX Active Time, no later than CSI reference resource and the UE drops the CSI report otherwise.

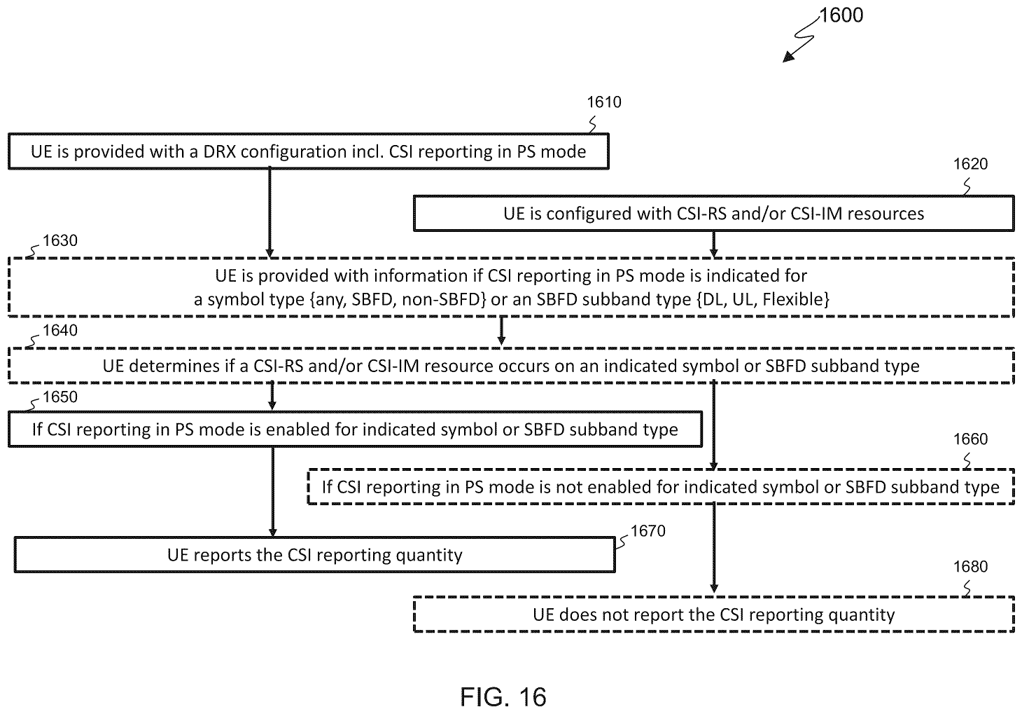

FIG. 16 illustrates an example flowchart for a process 1600 of CSI reporting in power-saving (PS) mode during DRX operation in a full-duplex communication system according to embodiments of the present disclosure. For example, the process 1600 may be performed by a UE such as UE 116 in FIG. 3 and a corresponding process may be performed by a base station such as gNB 102 in FIG. 2. The illustration of the process 1600 is for example and is not a limitation on the embodiments of the present disclosure.

The process 1600 begins with the UE being provided with a DRX configuration including a configuration for CSI reporting in PS mode, 1610. The UE is provided with a CSI-RS and/or a CSI-IM resource configuration, 1620. The UE is provided with information if CSI reporting in PS mode is indicated for a symbol type, e.g., SBFD, or non-SBFD, or any, or an SBFD subband type, e.g., SBFD DL subband, or SBFD UL subband, or SBFD flexible subband, 1630. The UE determines if a CSI-RS and/or CSI-IM resource occurs on an indicated symbol or an indicated SBFD subband type, 1640. If CSI reporting in PS mode is enabled for an indicated symbol or SBFD subband type, 1650, the UE determines a CSI reporting quantity based on the CSI-RS and/or CSI-IM resource and reports the CSI reporting quantity, 1670. If CSI reporting in PS mode is not enabled for an indicated symbol or SBFD subband type, 1660, the UE does not report the CSI reporting quantity, 1680.

With reference to Rel-17 NR specifications, a UE can report for an active DL BWP a MinTimeGap value that is X slots prior to the beginning of a slot where the UE would start the drx-onDurationTimer, the UE is not required to monitor PDCCH for detection of DCI format 2_6 during the X slots, where X corresponds to the MinTimeGap value of the SCS of the active DL BWP as described in [3], e.g., X=1 slot (Value 1) or X=6 slots (Value 2) for the case of SCS=30 kHz.

In one embodiment, a UE can provide information to a gNB based on a new parameter MinTimeGap-rxx with respect to a supported or required time duration for a Wake-up signaling indication associated with PDCCH receptions in a DRX on-period of a DRX cycle for a slot or symbol type, or based on an SBFD subband type.

For example, a slot or symbol type may correspond to ‘SBFD’ or ‘non-SBFD’, or may correspond to ‘D’ or ‘F’ or ‘U’. For example, an SBFD subband type may correspond to an SBFD DL subband, an SBFD UL subband, or an SBFD flexible subband. For example, DCP-Config-rxx can include a set or combination of symbol or slot types such as ‘D and F’ or a set or a combination of SBFD subband types such as ‘SBFD DL and flexible subband’ with respect to PDCCH receptions from a TRP of a cell.

For example, different supported/required time durations may be indicated with respect to ‘SBFD’ or ‘non-SBFD’, or for to ‘D’ or ‘F’ or ‘U’ symbol/slot types. For example, different supported/required time durations with respect to an SBFD subband type may be indicated wherein an SBFD subband type correspond to an SBFD DL subband, an SBFD UL subband, or an SBFD flexible subband. For example, DCP-Config-rxx can include a set or combination of symbol or slot types such as ‘D and F’ or a set or a combination of SBFD subband types such as ‘SBFD DL and flexible subband’ with respect to PDCCH receptions in the DRX on-duration of a DRX cycle associated with reception of a Wake-up indication from a TRP on a cell. For example, a value for a supported/required time duration for a same SCS and UE capability set according to the new parameter MinTimeGap-rxx may be larger than a (legacy) MinTimeGap value. A motivation is to support UE receiver bandwidth re-configuration when first receiving a PDCCH with a Wake-up indication in a DCI format 2_6 on a common search space set in the UE active DL BWP, with respect to second receiving of a PDCCH in a DRX on-duration in the CSS or USS of a UE active DL BWP or in an SBFD subband of the UE active DL BWP.

For example, when a UE reports for an active DL BWP a MinTimeGap-rxx value that is X slots prior to the beginning of a slot where the UE would start the drx-onDurationTimer, the UE is not required to monitor PDCCH for detection of DCI format 2_6 during the X slots when configured by DCP-Config-rxx for receptions in symbols or slots of type ‘SBFD’ or ‘non-SBFD’, respectively, or in a selected SBFD subband, where X corresponds to the MinTimeGap-rxx value of the SCS of the active DL BWP.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to receive physical downlink control channels (PDCCHs), the method comprising:
receiving a set of discontinuous reception (DRX) parameters associated with a subband full-duplex (SBFD) configuration;
receiving a first PDCCH that provides a downlink control information (DCI) format, wherein:
the DCI format includes a wake-up indication field enabling or disabling receptions of a second PDCCH, in a DRX on-period associated with a DRX cycle, for a symbol or a subband type, and
the enabling or disabling of receptions of the second PDCCH is based on the set of DRX parameters;
selecting, based on the wake-up indication field, the symbol or the subband type for receptions of the second PDCCH; and
receiving, based on (i) the selected symbol or subband type and (ii) the set of DRX parameters, the second PDCCH at a first occasion in a DRX on-duration or during a DRX active time,
wherein the first occasion is after reception of the first PDCCH and before an end of a time duration, and
wherein the symbol or subband type is one of:
an SBFD symbol or a non-SBFD symbol,
a downlink (DL) or a flexible symbol for an SBFD symbol, or
a first SBFD DL subband, a second SBFD DL subband, an SBFD flexible subband, or an SBFD UL subband.

2. The method of claim 1, wherein:
the wake-up indication field corresponds to a bit in a block of a DCI format 2_6, and
the method further comprises receiving a radio resource control (RRC) parameter providing the symbol or subband type associated with receptions of the second PDCCH.

3. The method of claim 1, wherein:
the wake-up indication field corresponds to a set of bits in a block of a DCI format 2_6,
the method further comprises:
receiving a first radio resource control (RRC) parameter providing a first symbol or subband type associated with receptions of the second PDCCH for a first set of codepoints from the set of bits, and
receiving a second RRC parameter providing a second symbol or subband type associated with receptions of the second PDCCH for a second set of codepoints from the set of bits.

4. The method of claim 1, wherein:
the wake-up indication field includes first bits and second bits in a block of a DCI format 2_6, and
the method further comprises:
receiving a first radio resource control (RRC) parameter providing a first symbol or subband type associated with receptions of the second PDCCH based on the first bits, and
receiving a second RRC parameter providing a second symbol or subband type associated with receptions of the second PDCCH based on the second bits.

5. The method of claim 1, further comprising:
determining a value for a timer or counter associated with the symbol or the subband type for receptions of the second PDCCH,
wherein receiving the second PDCCH further comprises receiving the second PDCCH while the timer or counter value is non-zero.

6. The method of claim 1, wherein the DRX on-duration or the DRX active time is associated with a long DRX cycle.

7. A user equipment (UE), comprising:
a transceiver configured to:
receive a set of discontinuous reception (DRX) parameters associated with a subband full-duplex (SBFD) configuration; and
receive a first physical downlink control channels (PDCCH) that provides a downlink control information (DCI) format, wherein:
the DCI format includes a wake-up indication field enabling or disabling receptions of a second PDCCH, in a DRX on-period associated with a DRX cycle, for a symbol or a subband type, and
the enabling or disabling of receptions of the second PDCCH is based on the set of DRX parameters; and
a processor operably coupled to the transceiver, the processor configured to select, based on the wake-up indication field, the symbol or the subband type for receptions of the second PDCCH,
wherein the transceiver is further configured to receive, based on (i) the selected symbol or subband type and (ii) the set of DRX parameters, the second PDCCH at a first occasion in a DRX on-duration or during a DRX active time,
wherein the first occasion is after reception of the first PDCCH and before an end of a time duration, and
wherein the symbol or subband type is one of:
an SBFD symbol or a non-SBFD symbol,
a downlink (DL) or a flexible symbol for an SBFD symbol, or
a first SBFD DL subband, a second SBFD DL subband, an SBFD flexible subband, or an SBFD UL subband.

8. The UE of claim 7, wherein:
the wake-up indication field corresponds to a bit in a block of a DCI format 2_6, and
the transceiver is further configured to receive a radio resource control (RRC) parameter providing the symbol or subband type associated with receptions of the second PDCCH.

9. The UE of claim 7, wherein:
the wake-up indication field corresponds to a set of bits in a block of a DCI format 2_6,
the transceiver is further configured to:
receive a first radio resource control (RRC) parameter providing a first symbol or subband type associated with receptions of the second PDCCH for a first set of codepoints from the set of bits, and
receive a second RRC parameter providing a second symbol or subband type associated with receptions of the second PDCCH for a second set of codepoints from the set of bits.

10. The UE of claim 7, wherein:
the wake-up indication field includes first bits and second bits in a block of a DCI format 2_6, and
the transceiver is further configured to:
receive a first radio resource control (RRC) parameter providing a first symbol or subband type associated with receptions of the second PDCCH based on the first bits, and
receive a second RRC parameter providing a second symbol or subband type associated with receptions of the second PDCCH based on the second bits.

11. The UE of claim 7, wherein:
the processor is further configured to determine a value for a timer or counter associated with the symbol or the subband type for receptions of the second PDCCH,
the transceiver is further configured to receive the second PDCCH while the timer or counter value is non-zero.

12. The UE of claim 7, wherein the DRX on-duration or the DRX active time is associated with a long DRX cycle.

13. A base station (BS), comprising:
a processor; and
a transceiver operably coupled to the processor, the transceiver configured to configured to:
transmit a set of discontinuous reception (DRX) parameters associated with a subband full-duplex (SBFD) configuration;
transmit a first physical downlink control channels (PDCCH) that provides a downlink control information (DCI) format, wherein:
the DCI format includes a wake-up indication field enabling or disabling receptions of a second PDCCH, in a DRX on-period associated with a DRX cycle, for a symbol or a subband type,
the enabling or disabling of receptions of the second PDCCH is based on the set of DRX parameters, and
the wake-up indication field indicates the symbol or the subband type for of the second PDCCH; and
transmit, based on (i) the selected symbol or subband type and (ii) the set of DRX parameters, the second PDCCH at a first occasion in a DRX on-duration or during a DRX active time,
wherein the first occasion is after transmission of the first PDCCH and before an end of a time duration, and
wherein the symbol or subband type is one of:
an SBFD symbol or a non-SBFD symbol,
a downlink (DL) or a flexible symbol for an SBFD symbol, or
a first SBFD DL subband, a second SBFD DL subband, an SBFD flexible subband, or an SBFD UL subband.

14. The BS of claim 13, wherein:
the wake-up indication field corresponds to a bit in a block of a DCI format 2_6, and
the transceiver is further configured to transmit a radio resource control (RRC) parameter providing the symbol or subband type associated with the second PDCCH.

15. The BS of claim 13, wherein:
the wake-up indication field corresponds to a set of bits in a block of a DCI format 2_6,
the transceiver is further configured to:
transmit a first radio resource control (RRC) parameter providing a first symbol or subband type associated with the second PDCCH for a first set of codepoints from the set of bits, and
transmit a second RRC parameter providing a second symbol or subband type associated with the second PDCCH for a second set of codepoints from the set of bits.

16. The BS of claim 13, wherein:
the wake-up indication field includes first bits and second bits in a block of a DCI format 2_6, and
the transceiver is further configured to:
transmit a first radio resource control (RRC) parameter providing a first symbol or subband type associated with the second PDCCH based on the first bits, and
transmit a second RRC parameter providing a second symbol or subband type associated with the second PDCCH based on the second bits.

17. The BS of claim 13, wherein:
the processor is further configured to determine a value for a timer or counter associated with the symbol or the subband type for the second PDCCH,
the transceiver is further configured to transmit the second PDCCH while the timer or counter value is non-zero.

18. The BS of claim 13, wherein the DRX on-duration or the DRX active time is associated with a long DRX cycle.
